(19) United States
(12) Patent Application Publication
(10) Pub. No.: US 2016/0023826 A1
(43) Pub. Date: Jan. 28, 2016

(54) ENCLOSING MATERIALS IN NATURAL TRANSPORT SYSTEMS

(71) Applicant: WIKIFOODS, INC., Cambridge, MA (US)

(72) Inventors: David A. Edwards, Boston, MA (US); John A. Lamppa, Hopkinton, MA (US); Jeffrey L. Vaughn, Newton, MA (US)

(21) Appl. No.: 14/776,034

(22) PCT Filed: Mar. 13, 2014
(86) PCT No.: PCT/US2014/025476

§ 371 Date: Sep. 14, 2015

Related U.S. Application Data
(60) Provisional application No. 61/792,897, filed on Mar. 15, 2013.
(60) Provisional application No. 61/815,765, filed on Apr. 25, 2013.

(51) Int. Cl. B65D 65/46; A23L 1/0532; A23L 1/00

(52) U.S. Cl. CPC B65D 65/463; A23L 1/0029; A23L 1/0052; A23L 1/0532; A23V 2002/00

(57) ABSTRACT

An edible composition, particularly an edible transport system, can be an edible substance and a cross-linked matrix encapsulating the edible substance, the cross-linked matrix comprising (1) at least one edible polymer and edible particles or (2) a plurality of edible polymers.

### RELATED APPLICATIONS

This application claims the benefit of U.S. Patent Application No. 61/792,897 filed on Mar. 15, 2013 and U.S. Patent Application No. 61/815,765, filed on Apr. 25, 2013; the entire teachings of these applications are incorporated herein by reference.

### TECHNICAL FIELD

This disclosure relates to vessels for encasing edible materials, and more particularly to edible and/or biodegradable vessels.

### BACKGROUND

Mankind has filled, carried, and transported water, other liquids (as well as solids, emulsions, slurries, foams, etc.) and edible materials in vessels made of pottery, glass, plastics and other materials since prehistoric times. While the nature of these vessels has evolved with advances in material manufacture and design, the basic principle of a vessel in the form of a container with a surface that encloses the edible material, either partially or completely, and from which the edible material can be removed, emptying the vessel, which can be refilled or discarded, has essentially not varied. Users continue to fill and empty containers with water, other liquids, and edible materials for various practical purposes.

### SUMMARY

In some embodiments, an edible composition, particularly an edible transport system, can be an edible substance and a cross-linked matrix encapsulating the edible substance, the cross-linked matrix comprising (1) at least one edible polymer and edible particles or (2) a plurality of edible polymers.

In some embodiments, an edible transport system can be an edible or potable substance and a cross-linked matrix comprising at least two different edible polymers encapsulates the edible or potable substance. In certain embodiments the at least two different edible polymers are charge cross-linked by multivalent ions, including cross-linking interactions between the edible particles and edible polymer or plurality of edible polymers via bridges formed by the multivalent ions.

In some embodiments of the edible transport system, the at least two different edible polymers are selected from the group consisting of a positively charged edible polymer, a neutrally charged edible polymer, a negatively charged edible particle, an amphipathic edible polymer, a zwitterionic edible polymer, and combinations thereof.

In some embodiments of the edible transport system, the at least two different edible polymers can be polysaccharides selected from the group consisting of a hydrocolloid, shellac, and fibers. In some embodiments the at least two different edible polymers comprise a hydrocolloid selected from the group consisting of an alginate, an agar, a starch, a gelatin, carrageenan, xanthan gum, gellan gum, galactomannan, gum arabic, a pectin, a milk protein, a cellulosic, a carboxymethylcellulosic, a methylcellulosic, gum tragacanth and karaya, xyloglucan, curdlan, a cereal β-glucan, soluble soybean polysaccharide, a bacterial cellulose, a microcrystalline cellulose, chitosan, inulin, an emulsifying polymer, konjac mannan/konjac glucomannan, a seed gum, and pullulan. In some embodiments the hydrocolloid comprises an alginate selected from the group consisting of sodium alginate, ammonium alginate, potassium alginate, and propylene glycol alginate.

In some embodiments of the edible transport system are edible particles in the cross-linked matrix. In some embodiments the edible particles are one of the group consisting of a positively charged edible particle, a neutrally charged edible particle, a negatively charged edible particle, an amphipathic edible particle, a zwitterionic edible particle, and combinations thereof. In some embodiments the edible particles provide enhanced performance to the matrix. In some embodiments the edible particles are stabilizers. In some embodiments the edible particles are selected from the group comprising a hydrocolloid, shellac, fibers, bagasse, tapioca, chitosan, sugar derivatives, chocolate, seaweed, and combinations thereof, and wherein the particles comprise a compound different from the polymer compound. In some embodiments the edible particles are particles selected from the group consisting of particles of a food, particles of an energy supplement, particles of a dietary supplement, particles of a confection, particles of a nutraceutical, particles of a pharmaceutical, particles of a sleep aid compound, particles of a weight loss compound, particles of a powdered vegetable, particles of a flavoring agent, particles of a sweetener, carbon allotropes, particles of a metabolic intermediate of a pharmaceutical, particles of a metabolic by-product of a pharmaceutical, and combinations thereof. In some embodiments the edible particles can be a size having a volume mean distribution between about 0.1 microns and about 1.0 microns, between about 0.1 microns and about 10.0 microns, between about 0.1 microns and about 100.0 microns, between about 0.1 microns and about 1.0 millimeters, between about 0.1 and about 3 millimeters.

In some embodiments of the edible transport system, the cross-linked matrix further can be an edible oil.

In some embodiments of the edible transport system, the edible or potable substance can be at least one of a powder, a gel, an emulsion, a foam, a solid, and combinations thereof. In some embodiments the edible or potable substance is selected from the group consisting of fruit, vegetable, meat, a dairy product, a carbohydrate food product, a botanical, an energy supplement, a dietary supplement, a confection, a nutraceutical, a pharmaceutical, a sleep aid compound, a weight loss compound, a powdered vegetable, a flavoring agent, a sweetener, a powdered food product, and combinations thereof.

In some embodiments of the edible transport system, the edible substance can be a liquid, particularly wherein the liquid comprises at least one of water, an alcohol, a juice, an alcohol mixed drink, a coffee product, a tea product, a soft drink, an energy supplement product, a dietary supplement, a confection, and combinations thereof.

In some embodiments is an edible transport system that can be an edible or potable substance, a first cross-linked matrix encapsulating the edible substance, a second cross-linked matrix encapsulating the first cross linked matrix, and edible particles with at least one of the first cross-linked matrix and the second cross-linked matrix. In some embodiments the edible particles are one of the group consisting of a positively charged edible particle, a neutrally charged edible particle, a negatively charged edible particle, an amphipathic edible particle, a zwitterionic edible particle, and combinations thereof.

In some embodiments the edible particles provide enhanced performance to the matrix.

In some embodiments the edible particles are stabilizers.

In some embodiments, the edible particles are selected from the group comprising a hydrocolloid, shellac, fibers, bagasse, tapioca, chitosan, sugar derivatives, chocolate, seaweed, and combinations thereof, and wherein the particles comprise a compound different from the polymer compound.

In some embodiments, edible particles are particles selected from the group consisting of particles of a food, particles of an energy supplement, particles of a dietary supplement, particles of a confection, particles of a nutraceutical, particles of a pharmaceutical, particles of a sleep aid compound, particles of a weight loss compound, particles of a powdered vegetable, particles of a flavoring agent, particles of a sweetener, carbon allotropes, particles of a metabolic intermediate of a pharmaceutical, particles of a metabolic by-product of a pharmaceutical, and combinations thereof.

In some embodiments the edible particles can be a size having a volume mean distribution between about 0.1 microns and about 1.0 microns, between about 0.1 microns and about 10.0 microns, between about 0.1 microns and about 100.0 microns, between about 0.1 microns and about 1.0 millimeters, between about 0.1 and about 3 millimeters.

In certain embodiments the at least one of the first cross-linked matrix and the second cross-linked matrix further comprise an edible oil. In other certain embodiments can be a particle layer arranged between each cross-linked matrix.

In certain embodiments the particle layer can be particles selected from the group consisting of particles of a food, particles of an energy supplement, particles of a dietary supplement, particles of a confection, particles of a nutraceutical, particles of a pharmaceutical, particles of a sleep aid compound, particles of a weight loss compound, particles of a powdered vegetable, particles of a flavoring agent, particles of a sweetener, particles of a metabolic intermediate of a pharmaceutical, particles of a metabolic by-product of a pharmaceutical, and combinations thereof.

In other embodiments is a method of preparing an edible composition, having the steps of providing an edible substance, and encapsulating the edible substance in a cross-linked matrix of at least two different polymers.

In certain embodiments of the method, the edible polymer and the edible particles or the plurality of edible polymers are charge cross-linked by multivalent ions, including cross-linking interactions between the edible particles and edible polymer or plurality of edible polymers via bridges formed by the multivalent ions.

In certain embodiments of the method, the edible polymer is one of the group consisting of a positively charged edible polymer, a neutrally charged edible polymer, a negatively charged edible particle, an amphipathic edible polymer, a zwitterionic edible polymer, and combinations thereof.

In certain embodiments of the method, the polymer can be a polysaccharide selected from the group consisting of a hydrocolloid, shellac, and fibers. In other certain embodiments of the method, the polymer comprises a hydrocolloid selected from the group consisting of an alginate, an agar, a starch, a gelatin, carrageenan, xanthan gum, gellan gum, galactomannan, gum arabic, a pectin, a milk protein, a cellulosic, a carboxymethylcellulosic, a methylcellulosic, gum tragacanth and karaya, xyloglucan, curdlan, a cereal β-glucan, soluble soybean polysaccharide, a bacterial cellulose, a microcrystalline cellulose, chitosan, inulin, an emulsifying polymer, konjac mannan/konjac glucomannan, a seed gum, and pullulan.

In certain embodiments of the method, the hydrocolloid can be an alginate selected from the group consisting of sodium alginate, ammonium alginate, potassium alginate, and propylene glycol alginate. In certain embodiments of the method, the cross-linked matrix can have edible particles.

In certain embodiments of the method, the particles are selected from the group consisting of particles of a hydrocolloid, particles of shellac, fibers, particles of bagasse, particles of tapioca, particles of chitosan, particles of sugar derivatives, particles of chocolate, particles of seaweed, and combinations thereof, and wherein the particles comprise a compound different from the polymer compound.

In certain embodiments of the method, the edible particles can be a size having a volume mean distribution between about 0.1 microns and about 1.0 microns, between about 0.1 microns and about 10.0 microns, between about 0.1 microns and about 100.0 microns, between about 0.1 microns and about 1.0 millimeters, between about 0.1 and about 3 millimeters.

In certain embodiments of the method, the edible particles are particles are selected from the group consisting of particles of a food, particles of an energy supplement, particles of a dietary supplement, particles of a confection, particles of a nutraceutical, particles of a pharmaceutical, particles of a sleep aid compound, particles of a weight loss compound, particles of a powdered vegetable, particles of a flavoring agent, particles of a sweetener, particles of a metabolic intermediate of a pharmaceutical, particles of a metabolic by-product of a pharmaceutical, and combinations thereof.

In certain embodiments of the method, the edible particles provide improved performance to the matrix.

In certain embodiments of the method, the edible particles are stabilizers.

In certain embodiments of the method, the edible particles are one of the group consisting of a positively charged edible particle, a neutrally charged edible particle, a negatively charged edible particle, an amphipathic edible particle, a zwitterionic edible particle, and combinations thereof.

In certain embodiments of the method, the cross-linked matrix further comprises an edible oil.

In certain embodiments of the method, the edible substance can be at least one of a powder, a gel, an emulsion, a foam, a solid, and combinations thereof.

In certain embodiments of the method, the edible substance is selected from the group consisting of fruit, vegetable, meat, a dairy product, a carbohydrate food product, a botanical, an energy supplement, a dietary supplement, a confection, a nutraceutical, a pharmaceutical, a sleep aid compound, a weight loss compound, a powdered vegetable, a flavoring agent, a sweetener, a powdered food product, and combinations thereof.

In certain embodiments of the method, the edible substance can be a liquid, particularly wherein the liquid comprises at least one of water, an alcohol, a juice, an alcohol mixed drink, a coffee product, a tea product, a soft drink, an energy supplement product, a dietary supplement, a confection, and combinations thereof.

### DESCRIPTION OF DRAWINGS

FIG. 1 shows the chemical structure of an alginate polymer -(M)ₘ-(G)ₙ- (M: mannuronate; G: guluronate).

FIG. 2 illustrates polymerization of sodium alginates via divalent cations (e.g., Ca²⁺).

FIG. 3 is a schematic illustrating bonding between positive particles (e.g., Ca²⁺ or Mg²⁺) and negative particles (e.g., alginate or food particles).

FIG. 4 illustrates multiple transport systems arranged in shells.

FIG. 5 illustrates a transport system having large particles suspended in an outer membrane layer.

FIG. 6 illustrates a transport system having small particles suspended in an outer membrane layer.

FIG. 7 illustrates a transport system having both large and small particles suspended in an outer membrane layer.

FIG. 8 illustrates a transport system having an outer membrane layer that is non-uniformly shaped.

### DETAILED DESCRIPTION

Transport systems contain and protect ingestible/edible substances, such as food, within edible or biodegradable membranes (matrix or matrices) and/or shells. The edible membranes/shells of transport systems can be formed from various substances allowing different compositions to be transported and consumed. As used herein, the terms “membrane(s),” “matrix” or “matrices,” and “shell(s)” may refer to similar or different materials or kinds of materials, depending on the type of object, how many barrier layers of any sort it may have, or the properties and contents of any such barrier layers. Thus, for some embodiments, the terms can be used interchangeably. In certain embodiments, membranes and/or membranes and shells are edible, providing nutritious benefits as well as reducing concerns about littering and waste. Embodiments of transport system described herein can have, e.g., varying shell or membrane thickness, one or more of a variety of chemical constituents, varying numbers of membranes, various consumable payloads, various shapes, and are constructed from various shell/membrane properties to provide a variety of flavors and textures and membrane characteristics. Embodiments of the transport systems can be made at large scale, using, for example, injection techniques, spray and spray drying techniques, fluidized-bed and other technologies. See, for example, PCT International Publication No. WO 2011/103594 and PCT International Application No. PCT/US2013/023500, which are incorporated herein by reference in their entirety.

Edible materials are generally solid, semi-solid or liquid in form, are capable of providing nutrition when consumed, and are typically provided in a form suitable for ingestion. Edible materials can be derived from many sources including plants and animals, particularly those generated by agriculture, or from artificial production methods including chemical synthesis. Edible refers to any substance that can provide for an organism's (e.g., a human or other mammal) nutritional needs or sensory desires, typically when consumed orally, and is usually non-toxic when properly consumed. Biodegradable refers to capable of being decomposed by actions of biological agents such as microorganisms, or by non-biological effects such as environmental exposure. Liquid refers to having a consistency like that of water or oil, that is to say, flowing freely but of constant volume. Solid refers to being characterized by structural rigidity and resistance to changes of shape and volume. Semi-solid refers to having a rigidity intermediate between a solid and a liquid. Viscosity refers to a fluid's resistance to flow, wherein gel-like liquids have higher viscosity—for example, honey is more viscous than water. Foam refers to a mass of small bubbles formed on or in a substrate, typically a liquid, but also includes ice cream, frozen yogurts and gelato. Frozen refers to a phase change in which a liquid is turned into a solid when its temperature is lowered beyond its freezing point. In some embodiments, the food material may be liquid, partially liquid, viscous, partially or fully solid, or contains several states of matter having different degrees of liquidity or solidness.

Ingestible substances include those that are edible or potable such as, for example, juice, chocolate, various medicines, and various other solids, liquids, slurries, emulsions, foams, etc. For example, foods, particularly fruits and vegetables, such as berries, plants, and beans, are provided in various states of matter: liquid, semi-solid, solid, and frozen. They can be mixed with each other and optionally one or more nutrients and additives in varying proportions can be added to the mixture to produce a large variety of novel food objects. Their texture and consistency can be manipulated by physical, chemical or biochemical means.

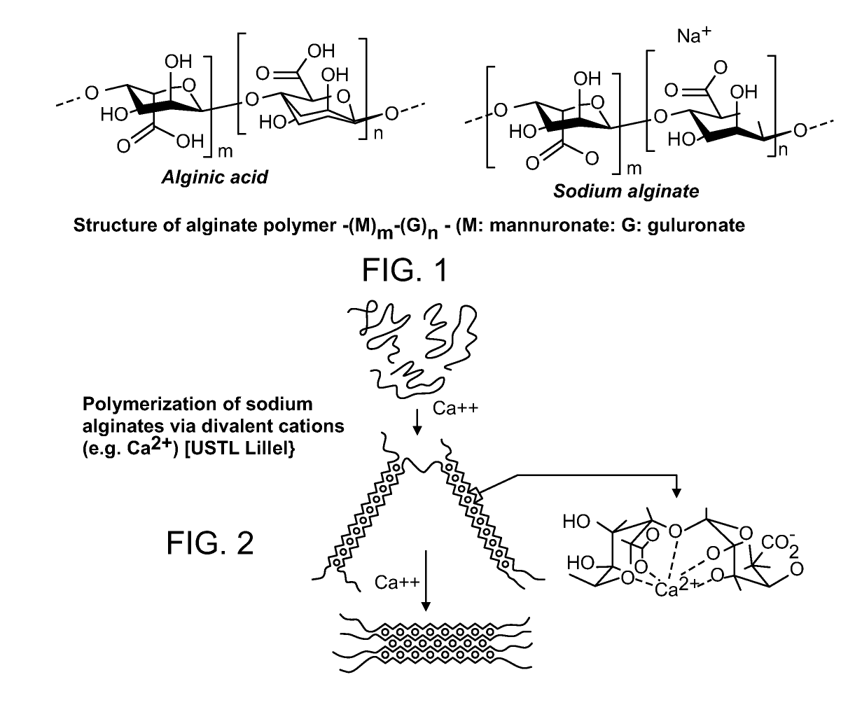

Membranes and shells of transport systems may be made by using any one of many edible and/or biodegradable polymers. FIG. 1 illustrates alginate (alginic acid) as an example of a polymer that can be used in forming a membrane of transport systems. Alginate is an anionic, polymeric polysaccharide, widely present in the cell walls of brown algae. It is a copolymer -(M)ₘ-(G)ₙ- segments composed of mannuronate M (mannurronic acid) and guluronate G (guluronic acid) monomeric subunits. The values of m and n, the ratio m/n, and the space distribution between M and G (i.e. presence of consecutive G-subunits and M-subunits, or randomly organized subunits) all play key roles in the chemical and physical properties of the final membrane.

Alginates have been applied to pharmaceutical preparations, impression-making materials (e.g., in dentistry and in prosthetics manufacturing), and in the food industry. Sodium alginates also have found application in restaurants, e.g., to create spheres of liquid surrounded by a thin jelly membrane. Modern chefs such as Ferran Adria have used sodium alginates to create “melon caviar,” “false fish eggs,” etc., by adding sodium alginates into a liquid (e.g., melon juice), then dropping the preparation in a calcium bath (calcium lactate or calcium chloride). Beyond their biocompatibility to human use, polymers such as alginate have the capacity to easily form a gel. To induce rapid gelation by electrostatic cross-linking, the naturally present Na⁺ ions are removed and replaced by divalent cations (e.g., Ca²⁺ or another multi-valent cation such as Mg²⁺; FIG. 2).

Our approach involves forming encapsulated vessels (transport systems) that use various particles, particulates and polymers, in combination or separately, to create desired properties of strength, stability, permeability, edibility and biodegradability for the transport systems to be easily moved and consumed. As used herein, the terms particle(s) and particulate(s) are used interchangeably.

In some embodiments, a consumable, edible product is encased in a polysaccharide membrane, for example, an alginate membrane. Methods for encasing a consumable edible product are found in U.S. Patent Application No. 61/591,054, U.S. Patent Application No. 61/601,852, U.S. Patent Application No. 61/591,262, U.S. Patent Application No. 61/591,233, and U.S. Patent Application No. 61/591,262, which are incorporated herein by reference in their entirety.

In some embodiments, ingestible particles embedded in a membrane are shown to improve the physical, chemical and/or physico-chemical performance characteristics of the membrane suitable for particular payloads (i.e. edible or potable substances), including, but not limited to, diffusion characteristics, pore size of the membrane, elasticity, etc. In certain embodiments, the ingestible particles impart a flavor, for example chocolate or various fruit flavors. When particles are charged and possess the same charge state as other membrane polymers or particulates, one can vary membrane component concentrations (for example, decreasing the membrane polymer concentration and increasing the membrane particulate concentration) while maintaining or optimizing membrane performance. In certain embodiments of, for example, an alginate based membrane, when particles carry the opposite charge state as alginate polymers or particulates, one can minimize or eliminate the need for a calcium solution or another multivalent ion by using particles to bind with alginates or another charged polymer. For non-alginate based systems, combinations of or homogenous particles can be used to encapsulate the edible material, or can be used in combination with polymers at lower weight %-by-mass than the particles (for example, less than 80%, less than 70%, less than 60%, less than 50%, less than 40%, less than 30%, less than 20%, less than 10% polymer). In certain embodiments, a thinner membrane can be sufficient to encapsulate a larger quantity of ingestible material, which may have further advantages of taste and texture. Particles contemplated herein include large food particles, for example greater than 1 millimeter (linseeds, sesame seeds, poppy seeds, chia seeds, chopped or pulverized foods including fruits, fruit skins, vegetables, etc.), small grains, and pulverized seeds, nuts, etc. In some embodiments, compositions use particulates less than about 1 millimeter.

In certain embodiments, particulates used for the membrane(s) can advantageously affect the membrane strength, diffusion permeability, and stability. Important variables when considering particulates as components for membranes include: 1) the particle charge or net charge of a heterogeneous or homogenous particulate mix, 2) the specific combinations of particulates for a heterogeneous mix, 3) the hydroscopic or hydrophilic nature of the particulates, 4) solubility of particulates in a liquid polymer, 5) aqueous solubility of the particles, 6) particle solubility in polar, non-polar or amphipathic solvents, 7) particle size, 8) heterogeneity of particle size, 9) heterogeneity of particle sizes in a heterogeneous or homogenous mix of particles, 10) shape of particulates in a heterogeneous or homogenous mix of particles, and 11) chemical and physical nature of the edible or potable substance to be encased in the membrane when interacting with the particulates.

In some embodiments, the particles are neutrally charged. In some embodiments, the particulates have various charge states, and can have an opposite charge as the membrane polymer or other membrane constituents. The overall charge state of the membrane polymer or other membrane constituents influences the choice of particulates, as particles oppositely charged to the charge state of the membrane polymer or particle matrix are likely incorporated into the membrane matrix and preferentially bonded. Oppositely charged particles could contribute to the formation of salt bridges within the membrane matrix and/or membrane polymeric subunit architecture.

In certain embodiments, polysaccharide polymers are used as the membrane polymer. Polysaccharide polymer based membranes are porous, with porosity determined by the chemical content and 2- and 3-dimensional geometry of the polymeric structure of the membrane, for example the structure of the polysaccharide chain. Therefore, particulates are used that can be appropriately accommodated by the pore structure of the membrane, whether as particles that can be intercalated between polymeric chains and/or embedded into the pores to act as a plug based on a particulate size and shape, electrostatically bind to create salt bridges, enhance Van der Waal's interactions that can contribute to overall membrane stability, etc. As described herein, various physical and chemical characteristics of the particulates are matched to the membrane structure and chemistry to achieve a desired effect, for example increased impermeability, elasticity, membrane strength-to-weight ratio, color, syneresis, etc.

In some embodiments, the particulates used for the membrane are sized at about 0.01 microns, at about 0.1 microns, at about 0.1 to 1.0 microns, at about 0.1 to 10 microns, at about 0.1 to 100 microns, at about 0.01 to about 1 millimeter or to about 3 millimeters, or at about 0.1 to about 1 millimeter or to about 3 millimeters. The size of the particulates may be important for embedment characteristics into the porous structure of the membrane.

The porosity of membranes is also determined in part by the ratios of the subunits and or the particulates that assemble to form the membrane. For example, alginate based membranes are composed of mannurronic acid and guluronic acid subunits. In general, for alginates, increasing the number of guluronic acid subunits relative to the number of mannurronic acid subunits will contribute to a loss of mobility of the membrane polymers, resulting in a stiffer and more stable membrane. However, the stability is also offset by increased porosity of the membrane. Also contributing to porosity can be the overall concentration of polymer used when in solution. All else being equal, increasing the concentration (and therefore the density) of a polymer can decrease the porosity of the final membrane. However, other considerations such as consumer preference or gustatory experience when ingesting the membrane will likely limit the range of desirable polymer concentrations. Therefore, ratios of polymeric building blocks and/or particulates of a membrane may be considered for determining membrane porosity with respect to particulate embedment, solution diffusion, and membrane permeability, and how these characteristics are related to each other.

In certain embodiments, the molecular weight of the membrane polymer is between about 2000 daltons and about 2,000,000 daltons or larger. In other embodiments, the polysaccharide polymer present in solution is between about 0.1% by weight and about 5% by weight, between about 0.1% and 10%, by weight, or greater.

In certain embodiments, not all of the particulates are incorporated into the membrane. Instead, in some embodiments, a layer of particulates remain unincorporated, and form a layer next to a membrane or between two or more membrane layers. The additional particulate layer therefore contributes to, for example, permeability, elasticity, strength, durability, syneresis, hygroscopy, hydrophobicity, etc., changes across and within membrane layers. Thus, the chemical nature of the particulates, for example if a hydrophobic particulate is used, can contribute to impeding the flow of liquid diffusion across an inner layer to an outer layer surface boundary. In some embodiments, particulates can be layered so that the particulate layer has multiple effects, for example an inner impermeability layer, a middle flavor/texture/payload (e.g. a pharmaceutical or supplement) layer, and an outer strength improving layer.

In some embodiments, the particulate used may serve as a flavoring agent, a sweetener, a bittering agent, or to impart a salty flavor. Various foods and flavorings in powdered or extract form are contemplated, including fruits, vegetables, herbs and spices, and various food salts (onion salt, garlic salt, sea salt, etc). Some embodiments use any of a variety of herbal extracts, energy supplements, dietary supplements, pharmaceuticals, over-the-counter drugs, sleep aids, appetite suppressants, weight gain agents, antioxidants, nutraceuticals, confections, and the like. As used herein, over-the-counter drugs refer to pharmaceutical compounds and compositions that had required a prescription but have been released from such prescription requirement for purchase and consumption.

In some embodiments, the edible or potable substance can be coated in a plurality of membranes. In certain embodiments, the membrane layers are distinct and melded. In other embodiments, the membrane layers are separate and distinct from other membrane layers. In certain embodiments, the same polymer, particulate, or combination of polymer(s) and/or particulate(s) is used for each of the multi-membrane coatings as described herein. In certain embodiments, different polymers, particulates, or combination of polymer(s) and/or particulate(s) are used for each membrane in a multi-membrane layer. In some embodiments, a multilayered outer membrane has the same polymer, particulate, or combination of polymer(s) and/or particulate(s) in each of the outer layers, but the membrane components are different than that used in, for example, the inner membrane or other inner membrane layers.

To accomplish the use of the same membrane components in a multi-membrane layered system while keeping the layers separate and distinct, in some embodiments, the inner membrane is first constructed, with or without additional particulates and/or polymers incorporated into the inner membrane. The membrane coated substance can then be layered with one or more additional polymer/particulate layers of homogenous or heterogeneous polymer/particulates, and then the particulate layer can be coated again with another membrane. The process may be repeated as many times as desired to construct a multilayered product.

Various membrane polymers are contemplated for use in the membrane forming layers. Considerations for choice of membrane polymers include inherent physico-chemical characteristics (charge states, functional groups, kinetic reaction rates of polymerization, ion complex formation and cross-linking, etc.), texture, polymerization characteristics, reactivity to chemical interactions and reactions such as pH, ionic strength, specific ions and ratios of ions during polymerization, presence of complexing agents (e.g., phosphates, citrate, ethylenediaminetetraacetic (EDTA) acid, acids, glucono-delta-lactone (GDL), etc.), shielding susceptibility of electrostatic character of polymer and polymeric strands, and cost effectiveness if used for commercial production. Polysaccharide polymers contemplated herein include, but are not limited to, shellac, various fibers and hydrocolloids such as alginate, an agar, a starch, a gelatin, carrageenan, xanthan gum, gellan gum, galactomannan, gum arabic, a pectin, a milk protein, a cellulosic, gum tragacanth and karaya, xyloglucan, curdlan, a cereal β-glucan, soluble soybean polysaccharide, a bacterial cellulose, a microcrystalline cellulose, chitosan, inulin, an emulsifying polymer, konjac mannan/konjac glucomannan, a seed gum, and pullulan. Combinations of these polysaccharides are also contemplated herein.

Other membrane compounds considered for use as structure forming compounds to modify or be used in combination with a polymer-based membrane (for example, a membrane consisting of a polysaccharide) include bagasse, tapioca, chitosan, polylactic acid, processed seaweed, chocolate, starch, gum arabic, cellulose based fibers, natural and synthetic amino acids and polymers thereof, proteins and sugars/sugar derivatives. Combinations of these compounds and compositions are also contemplated herein.

A multi-layered and/or multi-component membrane for transport systems can have several advantages: increased longevity or freshness of the edible or potable substance; limited diffusion of aqueous components of membrane polymers or edible and potables substances; decreased water activity of the potable or edible payload; wider spectrum of taste sensation and experience by a consumer when powders of different flavors and mouth feel sensations are used, for example, between layers in a multilayered composition, taste improvement of a pharmaceutical or over the counter drug(s) if used as the particulate, etc. Incorporation of particulates into the outer most membrane can modify membrane performance, for example the prevention of the outer membrane from polymerizing and or mechanically bonding with the inner or proximate membrane layer. Unincorporated particulates also likely form a physical barrier between membranes so that a chemical or mechanical bonding between membranes does not occur. Electrostatic repulsion/attraction, hydrophobicity and/or hydrophilicity of particulates and other solvent/solute interactions between particulates and membrane polymer components when may also contribute to preventing an interaction between a polymerized layer and a non-polymerized membrane component.

In some embodiments of a multilayered membrane, the proximately located membrane layers are made using the same polymer and the same particulates. In some embodiments, the proximately located membrane layers are made using different polymers and the same particulates to form the multiple membrane layers. In some embodiments, the proximately located membrane layers are made using the same polymers and different particulates to form the multiple membrane layers. In some embodiments, the proximately located membranes layers are made using different polymers and different particulates to form the multiple membrane layers. In some embodiments, different membranes are chosen wherein there is no inherent chemical or mechanical bonding between the membrane layers, thereby requiring no addition of particulates to the outer surface of the innermost membrane.

In some embodiments, membrane components, for example polysaccharides or proteins, are chemically modified with methods and compositions well known in the art. Modifications are important for altering functional groups of the membrane components which, in turn, can alter polymerization characteristics, chemical characteristics, physico-chemical characteristics, bonding propensities, electrostatics, hydrophobicity or hydrophilicity changes, diffusion propensity and resistance to diffusion, elasticity, stability, etc., in the final polymerized membrane. Modifications include, but are not limited to, carbamoylation, graft polymerization, etherification, esterification, reduction, oxidation, amination (e.g., (poly) lysine, arginine) halogenation, polymerization and degradation, complex formation with metals and salts, etc. See, for example, Chemical and Functional Properties of Food Saccharides (ISBN 978-0-8493-1486-5).

In some embodiments, various ions are employed for use in the polymerized membrane and related chemical processes. In, for example, the alginate polysaccharide membrane, ions are used to form cross-linkages between and among individual polymer strands. Various ion/counter ion salt complexes are contemplated for use herein, including, but not limited to, divalent cations such as calcium, potassium, magnesium, manganese, iron, zinc; trivalent cations including, but not limited to, manganese and iron; and salts thereof including, but not limited to, calcium lactate and calcium chloride.

In some embodiments, it is contemplated herein that micelles are formed within membranes and between membrane layers and/or between the inner membrane and the edible or potable substance. Micelles can alter the taste experience or mouth feel for the final encased product. Additionally, micelles engineered into the final membrane coated product may contain other ingestibles including sweeteners, flavors (fruits, herbs and spices, etc.), herbal extracts, energy supplements, dietary supplements, pharmaceuticals, over the counter drugs, sleep aids, appetite suppressants, weight gain agents, antioxidants, nutraceuticals, confections, etc., and combinations thereof.

The Code of Federal Regulations defines stabilizers as substances used to produce viscous solutions or dispersions, to impart body, improve consistency, or stabilize emulsions, including suspending and bodying agents, setting agents, jellying agents, and bulking agents, etc. (FDA Code of Federal Regulations Title 21, Subchapter B, Part 170, Subpart A, Section 170.3(o)(28)). Stabilizers may also contribute to reduction of ice crystal formation on frozen food surfaces or at interfaces of two or more edible substances. Various embodiments of stabilizers contemplated for use herein include, but are not limited to, acids, acidifiers, antibleaching agents, antibrowning agents, anticaking agents, antimicrobial agents, antioxidants, antioxidant synergists, antisticking agents, binders, bleaching agents, bodying agents, buffers, bulking agents, carbonating agents, carrier solvents, clarifying agents, cloud producing agents, colloidal stabilizers, color fixatives, color stabilizers, coloring agents, defoaming agents, disintegrating agents, dispersing agents, dough conditioners, drying agents, emulsifiers, enzyme activators, extraction solvents, fillers, film formers, filter aids, firming agents, flavor enhancers, flavoring adjuncts, flavoring agents, flour-treatment agents, foaming agents, free-flow agents, freezants, glazes, gelling agents, general purpose additives, humectants, intensifiers, leavening agents, lubricants, maturing agents, moisture-retaining agents, neutralizing agents, oxidizing agents, packing gases, pH control agents, plasticizers, polishes, preservatives, propellants, sequestrants, solubilizers, stabilizers, starch-modifying agents, surface-active agents, surface-finishing agents, suspending agents, sweetening agents, synergists, texture-modifying agents, texturizers, thickeners, wetting agents, whipping agents, and derivatives and combinations thereof.

In certain embodiments, stabilizers contemplated for use herein include, but are not limited to, 1,3-butylene glycol, acacia, acetic and fatty acid esters of glycerol, acetone, acetone peroxides, acetylated distarch adipate, acetylated distarch phosphate, acetylated monoglycerides, acid-treated starch, adipic acid, agar, alginic acid, alkaline-treated starch, aluminum ammonium sulfate, aluminum potassium sulfate, aluminum silicate, aluminum sodium sulfate, aluminum sulfate, aluminum ammonium sulfate, ammonium adipate, ammonium alginate, ammonium bicarbonate, ammonium carbonate, ammonium chloride, ammonium dihydrogen phosphate, ammonium hydrogen carbonate, ammonium phosphate, ammonium phosphatides, ammonium salts of phosphatidic acid, ammonium sulfate, anoxomer, ascorbic acid, ascorbyl palmitate, ascorbyl stearate, azodicarbonamide, beeswax, benzoic acid, benzoyl peroxide, beta-cyclodextrin, bleached starch, bone phosphate, brominated vegetable oil, butyl p-hydroxybenzoate, butylated hydroxyanisole, butylated hydroxymethylphenol, butylated hydroxytoluene, calcium acetate, calcium alginate, calcium aluminum silicate, calcium ascorbate, calcium benzoate, calcium bromate, calcium carbonates, calcium chloride, calcium citrate, calcium dihydrogen phosphate, calcium disodium ethylenediamine-tetraacetate, calcium DL-malate, calcium ferrocyanide, calcium gluconate, calcium hydrogen sulfite, calcium hydroxide, calcium iodate, calcium lactate, calcium lactobionate, calcium peroxide, calcium phosphate, calcium polyphosphates, calcium propionate, calcium pyrophosphatecalcium salts of fatty acids, calcium silicate, calcium sorbate, calcium stearate, calcium stearoyl lactylate, calcium sulfate, calcium tartrate, calciumiodiate, candelilla wax, carbamide, carbon dioxide, carnauba wax, carob bean gum, carrageenan, castor oil, cellulose gum, celluloses, chlorine, chlorine dioxide, cholic acid, choline salts and esters, citric acid, citric and fatty acid esters of glycerol, crosslinked sodium carboxymethylcellulose, cupric sulfate, D-alpha-tocopherol, dammar gum, decanoic acid, dedesoxycholic acid, dedextrins, dextrin ethyl cellulose, dehydroacetic acid, dextrose, diacetyltartaric acid esters of mono- and diglycerides of fatty acids, diammonium hydrogen phosphate, dicalcium pyrophosphate, diethyl pyrocarbonate, dilauryl thiodipropionate, dimethyl dicaronate, dimethylpolysiloxane, dioctyl sodium sulfosuccinate, dipotassium hydrogen phosphate, disodium ethylenediamine-tetraacetate, disodium hydrogen phosphate, disodium pyrophosphate, distarch phosphate, DL-alpha-tocopherol, DL-tartaric acid, dodecyl gallate, erythorbic acid, ethoxyquin, ethyl alcohol, ethyl cellulose, ethyl hydroxyethyl cellulose, ethyl p-hydroxybenzoate, ethyl protocatechuate, ethylene dichloride, esters of glycerol and thermally oxidized soy bean fatty acids, ethoxylated mono- and diglycerides, ethyl hydroxyethyl cellulose, ferric ammonium citrate, ferrous ammonium citrate, formic acid, gellan gum, gelatin, genipin, gibberellic acid, glucono delta-lactone, glycerin, glycerol, glycerol ester of wood rosin, guaiac resin, guar gum, gum acacia, gum arabic, gum ghatti, gum guaiac, heptylparaben, peroxide derivatives, hydrogen peroxide, hydroxylated lecithin, hydroxypropyl cellulose, hydroxypropyl distarch phosphate, hydroxypropylmethyl cellulose, hydroxypropyl starch, insoluble polyvinylpyrrolidone, iron gluconate, iron lactate, isoamyl gallate, isopropyl alcohol, isopropyl citrate mixture, kaolin, karaya gum, L(+)-tartaric acid, lactated monodiglycerides, lactic and fatty acid esters of glycerol, lactitol, lactylated fatty acid esters of glycerol and propylene glycol, lactylic esters of fatty acids, lauric acid, lecithin, locust bean gum, magnesium carbonate, magnesium DL-lactate, magnesium gluconate, magnesium hydrogen carbonate, magnesium hydroxide, magnesium hydroxide carbonate, magnesium L-lactate, magnesium oxide, magnesium salts of fatty acids, magnesium silicate, magnesium stearate, maltitol, mannitol, methyl alcohol, methyl ethyl cellulose, methylcellulose, methylene chloride, metatartaric acid, methylparaben, microcrystalline cellulose, milk protein, mineral oil, modified cellulose, modified starches, monoglyceride citrate, mono- and diglycerides, monostarch phosphate, myristic acid, nisin, nitrogen, nitrous oxide, nordihydroguaiaretic acid, o-phenylphenol, octanoic acid, octyl gallate, oleic acid, oxidized starch, oxystearin, palmitic acid, paraffin wax, pectin, pentapotassium triphosphate, pentasodium triphosphate, petrolatum, petroleum jelly, petroleum wax, phosphated distarch phosphate, phosphoric acid, pimaricin, poloxamer 331, poloxamer 407, polydimethylsiloxane, polydextroses, polyethylene glycols, polyglycerol esters of fatty acids, polyoxyethylenes, polypropylene glycol, polysorbates, polyvinylpolypyrrolidone, polyvinylpyrrolidone, potassium acetate, potassium acid tartrate, potassium adipate, potassium alginate, potassium benzoate, potassium bicarbonate, potassium carbonate, potassium chloride, potassium citrate, potassium dihydrogen citrate, potassium dihydrogen phosphate, potassium ferrocyanide, potassium gibberellate, potassium gluconate, potassium hydroxide, potassium iodate, potassium lactate, potassium metabisulfite, potassium nitrate, potassium nitrite, potassium persulfate, potassium phosphate, potassium polymetaphosphate, potassium polyphosphates, potassium L(+)-tartrate, potassium salts of fatty acids, potassium sorbate, potassium sulfate, potassium sulfite, potassium tripolyphosphate, processed eucheuma seaweed, propane-1,2-diol alginate, propionic acid, propyl gallate, propyl p-hydroxybenzoate, propylene glycol, propylene glycol alginate, propylene glycol esters of fatty acids, propylene glycol mono- and diesters, propylene oxide, propylparaben, quillaia extracts, rice bran wax, salts of fatty acids, shellac, silicon dioxide, sodium acetate, sodium acid, sodium acid pyrophosphate, sodium adipate, sodium alginate, sodium aluminosilicate, sodium aluminum phosphate, sodium ascorbate, sodium benzoate, sodium bicarbonate, sodium bisulfate, sodium carbonate, sodium carboxymethylcellulose, sodium caseinate, sodium chloride, sodium citrate, sodium dehydroacetate, sodium diacetate, sodium dihydrogen citrate, sodium dihydrogen phosphate, sodium dioxide, sodium DL-malate, sodium erythorbate, sodium ferrocyanide, sodium fumarate, sodium gluconate, sodium hydrogen carbonate, sodium hydrogen DL-malate, sodium hydrogen sulfite, sodium hydroxide, sodium hypophosphite, sodium L(+)-tartrate, sodium lactate, sodium lauryl sulfate, sodium metabisulfite, sodium metaphosphate, sodium nitrate, sodium nitrite, sodium phosphates, sodium polyacrylate, sodium polyphosphates, sodium potassium tartrate, sodium propionate, sodium pyrophosphate, sodium salts of fatty acids, sodium sesquicarbonate, sodium stearoyl lactylate, sodium stearyl fumarate, sodium sulfite, sodium tartrate, sodium thiosulfate, sodium tripolyphosphate, sorbic acid, sorbitan monolaurate, sorbitan monooleate, sorbitan monopalmitate, sorbitan monostearate, sorbitan tristearate, sorbitol, sorbitol sodium, sulfur dioxide, stannous chloride, starches, starch acetate, starch sodium octenylsuccinate, stearic acid, stearyl citrate, stearyl monoglyceridyl citrate, stearyl tartrate, succinic acid, succinylated monoglycerides, sucroglycerides, sucroses, sucrose acetate isobutyrate, sucrose esters of fatty acids, talc, tannic acid, tannins, tara gum, tartaric acid, tert-butylhydroquinone, tetrapotassium pyrophosphate, tetrasodium pyrophosphate, thiodipropionic acid, tocopherols, tragacanth, tragacanth gum, triacetin, triammonium citrate, tricalcium phosphate, trichloroethylene, triethyl citrate, trimagnesium phosphate, tripolyphosphate, tripotassium citrate, tripotassium phosphate, trisodium citrate, trisodium phosphate, urea, waxes, xanthan gum, xylitol, and derivatives and combinations thereof.

Certain embodiments of natural and artificial flavors contemplated for particulates include, but are not limited to, stevia rebaudioside A, glycyrrizin, thaumatin, sorbitol, erythritol, mannitol, monk fruit, pentadin, xylitol, brazen, sugar, dextrose, crystalline fructose, maltodextrin, trehalose, molasses, aspartame, aspartame acesulfame salt, neotame, acesulfame, saccharin, sucralose, neohesperidin dihydrochalcone, sodium, saccharin, cyclamates, alitame, dulcim, and combinations thereof.

Flavoring compounds contemplated for use in the membrane may be used to give the formulation payload a taste preferred by the end user, increase or enhance particular flavors or the perception of flavors. Flavors choices can include any fruit or vegetable flavor, or any artificial flavor, to elicit a desired taste perception (sweet, sour, bitty, salty and/or umami, and associated food or flavoring, e.g. mint, taste), as well as herbal or plant flavors that can otherwise be considered non-food (e.g., cinnamon), such as coffee, chocolate, and other confectionary flavors. Other flavor compounds considered as a novelty flavoring include, for example, beer and other alcoholic beverages, hemp, vomitus, and novel combinations of flavors (e.g. beer flavoring with caffeine).

Generally, dietary supplements may be considered as vitamins and/or minerals taken in addition to naturally obtained vitamins/minerals in food. Dietary supplements can be taken 1) to enhance the physical well-being or state of health of the end user, 2) as a health related supplement, or 3) as supplements required for enhancing deficient vitamin/mineral states in the end user. Dietary supplements can also add to a higher quality or perceived quality of the health state of the end user.

In certain embodiments, dietary supplements contemplated for use as membrane particles include, but are not limited to, Ascorbic Acid (Vitamin C), B Vitamins, Biotin, Fat Soluble Vitamins, Folic Acid, HCA (Hydroxycitric Acid), Inositol, pyruvate, Mineral Ascorbates, Mixed Tocopherols, Niacin (Vitamin B3), Orotic Acid, PABA (Para-Aminobenzoic Acid), Pantothenates, Pantothenic Acid (Vitamin B5), Pyridoxine Hydrochloride (Vitamin B6), Riboflavin (Vitamin B2), Synthetic Vitamins, Thiamine (Vitamin B1), Tocotrienols, Vitamin A, Vitamin D, Vitamin E, Vitamin F, Vitamin K, Vitamin Oils, Vitamin Premixes, Vitamin-Mineral Premixes, Water Soluble Vitamins, arsenic, boron, calcium, chloride, chromium, cobalt, copper, fluorine, iodine, iron, magnesium, manganese, molybdenum, nickel, phosphorous, potassium, selenium, silicon, sodium, strontium, sulfur, vanadium, zinc, and combinations thereof.

Energy supplements are designed to boost mental or physical activity. Various embodiments of ingestible energy supplements contemplated for use in membrane formulations include, but are not limited to, American ginseng, Red ginseng, Siberian ginseng, maca, rhodiola, ginger, guarana, turmeric, acetyl-L-carnitine, L-carnitine, creatine, taurine, L-phenylalanine, L-arginine, tyrosine, acetyl-tyrosine, N-acetyl L-tyrosine, ginko biloba, yerba-mate, kola nut, gotu kola, maitake, cordyceps sinensis, guarana, acai-berry, L-theanine, caffeine, quercitine, synephrine, green tea extract, theophylline, epigallocatechin gallate (EGCG), capsaicin, bee pollen, alpha-lipoic acid, and 1,3 dimethylamylamine (geranium), D-ribose, Fo-Ti, cha de bugre extract, St. Johns wort, and combinations thereof.

Oral health compounds can contribute to decreasing unwanted bacterial flora and/or covering up unwanted odors and/or flavors. Control of the unwanted flora can decrease incidence of tooth decay, halitosis, and potentially contributes to long-term health benefits including incidence of heart disease.

In certain embodiments, oral health compounds for use as membrane particles include, but are not limited to, fluoride, vitamin C, vitamin B, zinc, menthol, thymol, eucalyptus, sodium bicarbonate, vitamin K, chlorhexidine, xylitol, and combinations thereof.

Weight loss compounds are commonly divided into groups categorized as appetite suppressants, acting to manipulate hormonal and chemical processes in the body that otherwise increase hunger and/or the sense of feeling satiated (e.g. anorectics such as epinephrine and norepinephrine/noradrenaline), fat or cholesterol uptake inhibitors (such as green tea extract), gastrointestinal fillers, and thermogenic compounds which boost a normal metabolic rate of the individual and result in metabolism of fat stores, all of which are contemplated for use in the present invention. Weight loss compounds can be synthetic or natural.

In certain embodiments, weight loss compositions contemplated herein as particles for the membrane include, but are not limited to, hoodia, chitosan, chromium picolinate, conjugated linoleic acid, glucomannan, green tea extract, guar gum, guarana, guggal, senna, ephedra, bitter orange, fucoxanthin, white bean extract, vitamin D, human chorionic gonadotropin, resveratrol, capsaicin, chia, hoodia, L-carnitine, raspberry ketones, banana leaf, red clover, ginger, almonds, acai berry, flax seeds, leucine, lipodrene, and combinations thereof.

Sleep-aid compounds can assist in slowing the metabolic resting rate of an individual to allow one to relax and gain more restful or longer sleep periods. In certain embodiments, sleep aid compositions contemplated herein for use as membrane particles include, but are not limited to melatonin, 5-hydroxytryptophan, 5-hydroxytrypatmine, diphenhydramine, doxylamine, benzodiazepine, kava, serenite, chamomile, phenibut, catnip herb, chamomile, glycine, hops, L-theanine, L-tryptophan, glycine, GABA, valerian, and combinations thereof.

Various over the counter and prescription based (pharmaceutical) drugs are contemplated for easier ingestion, and in some instances a more pleasant taste, as would be experienced by the user.

In certain embodiments, over-the-counter (OTC) and prescription (pharmaceutical) drugs contemplated for use as a membrane particle include, but are not limited to, amikacin, gentamicin, kanamycin, neomycin, netilmicin, tobramycin, paromomycin, geldanamycin, herbimycin, loracarbef, ertapenem, doripenim, imipenem/cilastatin, meropenem, cefadroxil, cefazolin, cefalotin, cefalexin, cefaclor, cefamandole, cefoxitin, cefprozil, cefuroxime, cefixime, cefdinir, cefditoren, cefoperazone, cefotaxime, cefpodoxime, ceftazidime, ceftibuten, ceftizoxime, ceftriaxone, cefepime, ceftobiprole, teicoplanin, vancomycin, telavancin, clindamycin, lincomycin, daptomycin, azithromycin, clarithromycin, dirithromycin, erythromycin, roxithromycin, troleandomycin, telithromycin, spectinomycin, aztreonam, furazolidone, nitrofurantoin, amoxicillin, ampicillin, azlocillin, carbenicillin, cloxacillin, dicloxacillin, flucloxacillin, mezlocillin, methicillin, nafcillin, oxacillin, penicillin, piperacillin, temocillin, ticarcillin, ciprofloxacin, enoxacin, gatifloxacin, levofloxacin, lomefloxacin, moxifloxacin, nalidixic acid, norfloxacin, ofloxacin, trovafloxacin, grepafloxacin, sparfloxacine, temafloxacin, mafenide, sulfonamidochrysoiodine, sulfacetamide, sulfadiazine, silver, sulfadiazine, sulfamethizole, sulfamethoxazole, sulfanilamide, sulfasalazine, sulfisoxazole, trimethoprim, trimethoprim-sulfamethoxazole, demeclocycline, doxycycline, minocycline, oxytetracycline, tetracycline, clofazimine, dapsone, capreomycin, cycloserine, ethambutol, ethionamide, isoniazid, pyrazinamide, rifampicin, rifabutin, rifapentine, streptomycin, arsphenamine, chloramphenicol, fosfomycin, fusidic acid, linezolid, metronidazole, mupriocin, platensimycin, quinupristin/dalfopristin, rifaximin, thiamphenicol, tigecycline, tinidazole, Fluoxetine, sertraline, paroxetine, fluvoxamine, citalopram, escitalopram, mirtazapine, triazolam, quazepam, estazolam, temazepam, zolpidem eszopiclone zalepon, Trazodone, citalopram, escitalopram, desvenlafaxine, duloxetine, milnacipran, venlafaxine, tramadol, sibutramine, etoperidone, lubazodone, nefazodone, trazodone, reboxetine, viloxazine, atomoxetine, bupropion, dexmethylphenidate, methylphenidate, amphetamine, dextroamphetamine, dextromethamphetamine, lisdexamfetamine, amitriptyline, butriptyline, clomipramine, desipramine, dosulepin, doxepin, imipramine, iprindole, lofepramine, melitracen, nortriptyline, opipramol, protriptyline, trimipramine, amoxapine, maprotiline, mianserin, mirtazapine, isocarboxazid, moclobemide, phenelzine, selegiline, tranylcypromine, pirlindone, busipirone, tandospirone, aripiprazole, vilazodone, quetiapine, agomelatine, nefazodone, quetiapine, asenapine, carbamazepine, lithium, olanzapine, valproic acid, alprazolam, lorazipam, chlordiazepoxide, clonazepam, etizolam, tofizopam, Azelastine, cetirizine, clemastine, desloratadine, dimenhydrinate, diphenhydramine, doxylamine, fexofenadine, loratadine (Claritin), ketorolac tromethamine, pemirolast potassium, ketotifen, neodocromil sodium, loteprednol etabonate, ipratropium bromide, beclomethasone, dexamethasone, epinastine, fluticasone, oxymetazoline, triamcinolone, cromolyn sodium, flunisolide, mometasone, ciclesonide, carbinoxamine maleate, olopatadine, budesonide, montelukast, clemastine, epinephrine, fluticasone furoate and levocetirizine, Celecoxib (Celebrex), etodolac (iodine), meloxicam (Mobic), rofecoxib (Vioxx), valdecoxib (Bextra), ibuprofen, naproxen, diclofenac, flurbiprofin, indomethacin, ketoprofen, ketorolac, nabumetone, oxaprozin, piroxicam, sulindac, Aspirin, Acetaminophen, Pseudoephedrine HCl, Dextromethorphan, Chlorpheniramine Maleate, Pseudoephedrine HCl, Xylometazoline, Benzododecinium, Butamirate citrate, Clemastine, diphenynhydramine citrate, diphenynhydramine, Chlorpheniramine Maleate, Dextromethorphan Hydrobromide, Oxymetazoline hydrochloride, guaifenesin, ibuprofen, phenylephrin, Acid production control (omeprazole), laxative (loperimide) smoking (nicotine), Ezetimibe, Simvastatin, Eptifibatide, Sitagliptin, Metformin, Losartan Potassium, Hydrochlorothiazide, Finasteride, Enalapril maleate, Hydrochlorothiazide, raltegravir, peginterferon alpha-2b, caspofungin acetate, imipenem and cilastatin sodium, ertapenem sodium, moxifloxacin, posaconazole, Indinavir sulfate, efavirenz, ribavirin USP, peginterferon alfa and ribavirin, rizatriptan benzoate, dorzolamide hydrochloride, Montelukast sodium, infliximab, mometasone furoate monohydrate, desloratadine, etoricoxib, mometasone furoate, golimumab, albuterol sulfate, mometasone furoate/formoterol fumarate, temozolomide, fosaprepitant dimeglumine, Interferon alfa-2b, Gardasil™, ProQuad™, MMR II™, Varivax™, RotaTeq™, Pneumovax™, Zostavax™, alendronate sodium, etonogestrel/ethinyl estradiol, follitropin beta, etonogestrel, desogestrel, Zelephon, Zolpidem Tartrate, estazolam, flurazepam, temazepam, eszopiclone, zaleplon, zolpidem, Ramelteon, amitriptyline, doxepin, mirtazapine and trazodone, pharmaceutically active metabolic products and/or metabolic intermediates thereof, and combinations thereof. In particular embodiments, the pharmaceutical is a sustained release pharmaceutical compound.

Various other compounds are contemplated for use as membrane particles. For example, antioxidants, hormones and other proteins, enzymes, amino acids, probiotics, etc., and combinations thereof, may be desirable.

In certain embodiments, hormones are used for hormone replacement and supplementation. Various hormones contemplated for use as a membrane particle include, but are not limited to, apidonectin, aldosterone, androgen, natriuretic peptide, 7-Keto-DHEA, Androstenedione, dihydroepiandrosterone (DHEA), Melatonin, Nor-Androstenedione, pregnenolone, progesterone, 19 Nor-4-Androstendiol, 19 Nor-4-Androstenedione, 19 Nor-5-Androstenediol, 19 Nor-5-Androstendione, 3-Indolebutyric Acid, 4 Androstendiol, 4 Androstendione, 6 Furfurylaminopurene, 6-Benzylaminopurine, calcitonin, cortisol, erythropoietin, gonadotropin, human growth hormone (HGH), incretins, leptin, lutenizing hormone, orexin, parathyroid hormone, pregnenolone, progesterone, prolactin, relaxin, renin, testosterone, vasopressin, and combinations thereof.

In other embodiments, enzymes and amino acids are contemplated for use as a membrane particle, and include, but are not limited to, alpha galactosidase, amylase, bromelain, cellulase, papain, peptidase, protease, proteolytic enzymes, superoxide dismutase, trypsin, betaine, casein, glutamic Acid, L-alanine, L-arginine, L-cysteine, L-glutamine, L-glycine, L-histidine, L-isoleucine, L-leucine, L-lysine, L-methionine, L-ornithine, L-phenylalanine, L-proline, L-taurine, L-threonine, L-tryptophan, L-tyrosine, L-valine, N-acetly-L-cysteine, protein soluble soy, soy protein isolates, whey protein concentrates, whey protein isolates, and combinations thereof.

In certain embodiments, antioxidants contemplated for use as membrane particulates include, but are not limited to, carotenoids, flavonoids, isoflavones, tocopherol, tocotrienol, lipoic acid, melatonin, superoxide dismutase, coenzyme Q10, alpha lipoic acid, vitamin A, chromium biotin, selenium and ascorbic acid.

In certain embodiments, carotenoids contemplated for use as membrane particles include alpha-carotene, beta-carotene, cryptoxanthin, lycopene, lutein, zeaxathin, apocarotenal astaxanthin, canthaxanthin, lutein/lutein esters, etc., and combinations thereof.

In some embodiments, flavonoid used as membrane particles include esveratrol, quercetin, rutin, catechin, proanthocyanidins, acai berry extract, raspberry extract, cranberry extract, pomegranate extract, plum extract, cherry extract, rosemary extract, etc., and combinations thereof

In some embodiments, isoflavones are used as membrane particles, including, but not limited to, genistein, daidzein, biochanin A, and formononetin.

Further embodiments for particulates in membranes include probiotics to re-establish healthy intestinal bacterial flora. In certain embodiments, probiotics for use in the present invention include, but are not limited to, Bacillus coagulans GBI-30, 6086, Bifidobacterium animalis subsp. lactis BB-12, Bifidobacterium longum subsp. infantis 35624, Lactobacillus acidophilus NCFM, Lactobacillus paracasei St11 (or NCC2461), Lactobacillus johnsonii NCC533), Lactobacillus plantarum 299v, Lactobacillus reuteri ATCC 55730 (Lactobacillus reuteri SD2112), Lactobacillus reuteri Protectis (DSM 17938, daughter strain of ATCC 55730), Saccharomyces boulardii, Lactobacillus rhamnosus GR-1 & Lactobacillus reuteri RC-14, Lactobacillus acidophilus NCFM & Bifidobacterium bifidum BB-12, Lactobacillus acidophilus CL1285 & Lactobacillus casei LBC80R, Lactobacillus plantarum HEAL 9 & Lactobacillus paracasei 8700:2, Lactobacillus bulgaricus, Streptococcus thermophiles, and/or Bifidobacterium spp, and combinations thereof.

Plants and plant extracts can provide compositions for dietary supplements, energy products, antioxidants, sleep-aids, weight-loss products, nutraceuticals, oral health compounds, novelty products, etc. Such compositions may be categorized as botanical supplements and botanical extracts. Aqueous or oil based botanical supplements can be combined at low volume with powdered components or be combined into membrane components, edible or potable substances, or into micelles engineered into membranes.

In certain embodiments, botanical extracts and plant-based supplements for use as membrane components include, but are not limited to, Acerola Extracts, Alfalfa, Blue Green algea, Aloe, Amla, Angelica Root, Bacopa Monnieri, Mucuna Pruriens, Anise Seed, Arnica, Artichoke, Ashwagandha, Astragalus, Ayurvedic Herbs, Barberry, Barley Grass, Barley Sprout Extract, Benzoin, Bilberry, Bioflavonoids, Bitter Melon, Bitter Orange, Black Cohosh, Black Currant, Black Walnut, Bladderwrack, Blue Cohosh, Blueberry, Boswellia, Brahmi, Broccoli, Burdock, Butcher's Broom, Calendula, Capsicum, Cascara Sagrada, Cat's Claw, Catnip herb, Cayenne, Celery Seed, Certified Organic Herbs, Chamomile, Chapparal, Chaste Berry, Chicory Root, Chinese Herbs, Chlorella, Chlorophyll, Citrus Aurantium, Cocoa, Coriander, Corn Silk, Cranberry, Curcuminoids, Damiana, Dandelion, Devil's Claw, Diosgenin, Dong Quai, Echinacea, Elderberry, Elecampane Root, Ephedra, Essential Oils, Eucalyptus, Evening Primrose, Eyebright, Fennel, Fenugreek, Feverfew, Flax Products, Garcinia, Cambogia, Garlic, Gentian, Ginger, Ginkgo, Biloba, Ginseng (American), Ginseng (Panax), Ginseng (Siberian), Goldenseal, Gotu Kola, Grape Seed Extract, Grape Skin Extract, Grapefruit Seed Extract, Green Food Products, Green Lipped Mussel Powder, Green Tea, Griffonia simplicifolia, Guarana, Guggul, Gymnema Sylvestre, Hawthorne, Herbal Extracts, Herbal Teas, Hops, Horehound, Horse Chestnut, Horsetail, Hysop, Ipriflavone, Jojoba Oil, Juniper Berries, Kava Kava, Kelp Extract, Kombucha, Kudzu, Larch, Lavender, Lemon Balm, Licorice Extract, Linden Flowers, Lobelia, Maca, Maitake Mushroom, Marshmallow, Milk Thistle, Molasses, Mushrooms, Neem, Nettle, Noni, Nopal, Oatstraw, Octacosanol, Olive Extract, Orange Peel Extract, Oregano Oil, Oregon Mountain Grape, Organic Sweeteners, Parsley, Passion Flower, Pau d'Arco, Pennyroyal, Peppermint, Pfaffia Paniculata, Pine Bark Extract, Piper Longum, Pygeum Africanum, Quercitin, Raspberry Powder, Reishi Mushroom, Resveratrol Extract, Rhubarb Root, Rice Products, Rose Hips, Rosemary Extract, Sage, Sarsaparilla, Saw Palmetto, Schizandra, Seaweed extracts, Senna, Shatavari, Shiitake Mushroom, Silymarin, Skullcap, Slippery Elm, Soy Isoflavones, Soybean Products, Spirulina, St. John's Wort, Stevia, Summa, Tea Tree Oil, Terminalia ajruna, Tribulus terrestris, Triphala, Tumeric, Uva Ursi, Valerian Extract, Vegetable Extracts, Vitex, Wheat Germ, White Willow Bark, Wild Cherry bark, Wild Yam, Witch Hazel, Wormwood, Yarrow, Yellow Dock, Yerba Sante, Yohimbine, Yucca, 20-ECD 7-9%, Acetyl L-Carnitine HCl 99%, 4-Androstenedione 99%, Adenophora Tetraohylla Ext 5:1, Alisma Extract 10:1, Alpha Lipoic Acid 99%, Angelica Root Extract, Arbutin 99%, Artemisia Extract 4:1, Artichoke Extract 5%, Globe Asparagus Extract 4:1, Asparagus Powder, Astragulus Extract 10:1, Astragulus Extract 4:1, Astragulus Extract 5:1, Astragulus Root Extract 0.5%, Astragulus Root Powder, Atractylodes Extract 10:1, Avena Sativa Extract 10:1, Avena Sativa Extract 4:1, Barbed Skullcap Extract 10:1, Barberry Extract 10%, Bee Pollen Powder, Beta-Sisterol 35%, Bilberry Extract 10:1, Bitter Melon Extract 8:1, Black Cohosh Extract 2.5%, Black Cohosh Root Powder, Black Pepper Extract 4:1, Black Soy Bean Extract 10:1, Bone Powder, Boswellia Serrata Extract 65%, Broccoli Sprout Extract 10:1, Buchu Leaf Powder, Buplerum (Chai Hu) Extract 5:1, Burdock Root Extract 4:1, Cabbage Extract 4:1, Caffeine (Natural) 86-87%, Caffeine 99%, Calcium Citrate Granular 21%, Calcium-Pyruvate 99%, Carrot Root Extract 4:1, Cassia Nomame Extract 4:1, Catnip Extract 4:1, Cat's Claw (Inner Bark), Powder Cauliflower Extract 4:1, Celandine (Greater) Extract 4:1, Celery Seed Extract, Cetyl Myristoleate 11%, Cetyl Myristoleate 20%, Chaenomeles Extract 4:1, Chamomile Flower Extract 10:1, Chamomile Flower Extract 4:1, Chaste Tree Berry Extract 4:1, Chitin Chitosan 80%, Chitosan 90%, Chondroitin Sulfate 90%, Chrysin 99%, Cinnamon Powder, Cistanches Extract 5:1, Citrus Aurantium Extract 6%, Citrus Bioflavonoid Complex 13%, Citrus Peel Extract 5:1, Clove Extract 5:1, Clove Powder, Coca Extract 4:1, Codonopsis Pilosula Extract 5:1, Colostrum, Common Peony Extract 8:1, Cordyceps Extract 7%, Cornsilk Extract 4:1, Cornsilk Powder, Corydalis Extract 10:1, Cranberry Extract 4:1, Cranberry Powder, Curcumin Extract 95%, Cuscuta Extract 5:1, Damiana Extract 4:1, Damiana Leaves Powder, Dandelion Powder, Dandelion Root Extract 6:1, Danshen Extract 80%, D-Calcium Pantothenate, Devil's Claw Extract 2.5%, Devil's Claw Extract 4:1, Devil's Claw Root Powder, DHEA 99%, Diosgenin 95%, DL-Phenyl Alanine, DMAE Bitartrate, Dong Quai Extract 10:1, Dong Quai Extract 4:1, Dong Quai Root Powder, D-Ribose, Echinacea Angustifolia Extract 4:1, Echinacea Leaf Powder, Echinacea Purpurea Extract 10:1, Echinacea Purpurea Extract 4%, Echinacea Purpurea Extract 4:1, Echinacea Purpurea Root Powder, Elder Flower Extract 4:1, Elderberry Extract 20:1, Elderberry Extract 4:1, Epimedium Extract 10%, Epimedium Extract 10:1, Epimedium Extract 4:1, Epimedium Extract 5%, Epimedium Powder, Eucommia (Du Zhong) Extract 5:1, Fennel Seed Extract 4:1, Fennel Seed Powder, Fenugreek Extract 4:1, Fenugreek Extract 6:1, Feverfew Extract 5:1, Fisetin, Fish Oil Powder, Forbidden Palace Flower Extract 5:1, Forskolin 8%, Fo-Ti Extract 12:1, Fo-Ti Extract 8:1, Fo-Ti Powder, Gardenia Extract 8:1, Garlic Extract 4:1, Garlic Powder, Gentian Root Extract 6:1, Ginger Extract 4:1, Ginger Root Extract 5%, Ginger Root Powder, Ginkgo Biloba Extract 8:1, Ginkgo Extract 24/6%, Ginkgo Extract 24/6%<5, Ginkgo Extract 24/7%, Ginkgo Leaf Extract 4:1, Ginkgo Leaf Powder, Ginseng (Korean) Powder, Ginseng (Panax) Extract 5%, Ginseng (Panax) Extract 8%, Ginseng (Panax) Extract 80%, Glucomannans Konjac Powder, Glucosamine HCl 95%, Granulation Glucosamine HC199%, Glucsosamine Sulfate Potassium, Glucsosamine Sulfate Sodium 95%, Granulation Glucsosamine Sulfate Sodium 99%, Goldenrod Extract 4:1, Goldenrod Powder, Goldenseal Root Extract 14%, Goldenseal Root Powder, Gotu Kola Extract 16%, Gotu Kola Extract 4:1, Gotu Kola Extract 8:1, Gotu Kola Powder, Grape Fruit Powder, Grape Seed, Grape Seed Extract 10:1, Grape Seed Extract 20:1, Grape Seed Extract 4:1, Grape Seed Extract 5:1, Grape Seed Extract 95%, Grape Seed Powder, Grape Skin Extract 20:1, Grape Skin Extract 4:1, Grass-Leaved Sweetflai Extract, Green Lip Mussel Extract, Green Tea Extract 30%, Green Tea Extract 4:1, Green Tea Extract 95%, Guarana Seed Extract 10%, Guarana Seed Extract 22%, Guarana Seed Extract 25%, Guggul Extract 10%, Guggul Extract 2.5%, Gugulipid Extract 10%, Gymnema Sylvestre Extract 25%, Gymnema Sylvestre Powder, Hawthorne Berry Extract 4:1, Hawthorne Berry Powder, Hawthorne Leaf Extract 2%, Hearbacious Peony Extract 5:1, Hesperidin Extract 98%, Honeysuckle Herb Extract 4:1, Hops Flower Extract 4:1, Horehound Extract 10:1, Horehound Extract 4:1, Horehound Herb Powder, Horse Chestnut Extract 20%, Horse Chestnut Extract 4:1, Horse Chestnut Powder, Horsetail Extract 7%, Horsetail Powder, Houttuynia Cordata Extract 5:1, Hydrangea Extract 8:1, Hydroxy Apatite, Hyssop Extract 4:1, Indole-3-Carbinol 99%, Isodon Glaucocalyx Extract 10:1, Japanese Knotweed Extract, Jiaogulan Extract 4:1, Jin Qian Cao Extract 4:1, Jingjie Extract 4:1, Jujube Fruits Extract 4:1, Kava Kava Extract 30%, Kava Kava Powder, Kelp Extract 4:1, Kelp Powder, Kidney Bean Extract 10:1, Kidney Bean Pole 4:1, Kidney Bean Pole 8:1, Kidney Bean Powder, Kola Nut Extract 10%, Kudzu Extract 4:1, Kudzu Extract 6:1, Lettuce Extract 4:1, L-Glutamine, L-Glycine, Licorice Extract 10%, Licorice Extract 5:1, Licorice Powder, Lotus Leaf Powder, L-Tyrosine, Lycium Fruit Extract 4:1, Lycium Fruit Extract 5:1, Ma Huang Extract 6%, Ma Huang Extract 8%, Maca Extract 0.6%, Maca Root Powder, Magnesium Stearate, Magnolia Bark Powder, Magnolia Officinal Extract 4:1, Maca Extract 4:1, Maitake Mushroom Extract 4:1, Marigold Extract (Lutein 5%), Methozyisoflavone 99%, Methylsufonylmethane 99%, Milk Thistle Extract 4:1, Milk Thistle Seed Extract 80% silymarin, Morinda Extract 5:1, Motherwort Extract 4:1, Motherwort Powder, Mucuna Pruriens Extract (15% L-Dopa), Muira Puama Extract 12:1, Muira Puama Extract 4:1, Muira Puama Powder, Mushroom Extract 10:1 (feishi), Mustard Seed Extract 8:1, Myrobalan Extract 4:1, Myrrha Gum Extract 2.5%, N-Acetyl-D-Glucosamine, N-Acetyl-L-Cysteine, Nettle Extract 7%, Nettle Leaf Extract 4:1, Nettle Leaf Powder, Noni Powder, Olive Leaf Extract 18%, Olive Powder Orange Peel Extract 4:1, Orange Peel Powder, Oroxylum Indicum Extract 4:1, Oroxylum Indicum Powder, Oyster Meat Powder, Oyster Shell Powder, Papaya Fruit Extract 4:1, Parsley Extract 10:1, Parsley Extract 4:1, Parsley Leaf Extract 4:1, Parsley Powder, Passion Flower Extract 4:1, Passion Flower Powder, Pau D'Arco Powder, Peppermint Extract 4:1, Peppermint Powder, Perilla Seed Extract 4:1, Periwinkle Extract 4:1, Pharbitidis Extract 4:1, Phosphatidyl Serine 20%, Pine Bark Extract 4:1, Plantago Asiatica Leaf Extract 5:1, Polygala Tenoifolia Extract 4:1, Polygonum Extract, Polygonum Extract 4:1, Pregnenolone 99%, Propolis Extract 3%, Pseudoginseng Extract, Psyllium extract 4:1, Pumpkin Seed Extract 4:1, Purple Willow Bark Extract 4:1, Purslane Herb Extract 4:1, Pygeum Extract 4:1, Quercetin, Radish Extract 4:1, Radix Isatidis Extract 4:1, Radix Polygoni Extract 4:1, Red Clover Extract 4:1, Red Pepper Extract 4:1, Red Yeast Rice, Red Yeast Rice Extract 10:1, Red Yeast Rice Powder, Rehmannia Root Extract 4:1, Reishi Mushroom Extract 4:1, Rhodiola Rosea Extract 4:1, Rhododendron Extract 4:1, Rhododendron Powder, Rhubarb Extract 4:1, Rhubarb Root Powder, Riboflavin (B2), Rice Powder, Rosemary Extract 20%, Rumex Madaid Extract 4:1, Salvia Extract 10:1, Salvia Extract 4:1, SAMe, Saw Palmetto Extract 25%, Saw Palmetto Extract 4:1, Saw Palmetto Extract 45-50%, Saw Palmetto Oil 85-95%, Saw Palmetto Powder, Schizandra Extract 10:1, Schizandra Extract 4:1, Scopolia Acutangula Powder, Sea Cucumber Powder, Senna Leaf Powder, Sesame (Black) Seed Powder, Shark Cartilage Powder, Shitake Mushroom Extract, Siberian Ginseng Extract 0.8%, Siberian Ginseng Extract 4:1, Siberian Ginseng Powder, Skullcap Extract 4:1, Skullcap Extract 4:1, Slippery Elm Powder, Sodium-Pyruvate 99%, Songaria Cynomorium Extract 4:1, Songaricum Powder, Spirulina Powder, St. John's Wort Extract 0.3%, St. John's Wort Extract 4:1, St. John's Wort Powder, Stanol 50%, Stephania Extract 4:1, Stevia Extract 4:1, Sulfate N+Suma Root Extract 4:1, Suma Root Powder, Taurine Powder, Thorowax Extract 4:1, Tomato Extract, Tomato Extract (0.2% Lycopene), (trans)-Resveratrol 20-25%, Tribulus Extract 10:1, Tribulus Extract 40%, Tribulus Powder, Trifal Extract 4:1, Turmeric Extract 4:1, Turmeric Root Powder, Uva Ursi Extract 4:1, Uva Ursi Powder, Valerian Root Extract 0.8%, Valerian Root Extract 4:1, Valerian Root Powder, Vinca Major Seed Extract 10:1, White Wax Extract 4:1, White Willow Bark 15% (total salicins), White Willow Bark 20%, White Willow Bark 25%, White Willow Bark Extract 4:1, White Willow Bark Powder, Wild Yam Extract 10:1, Wild Yam Extract 16%, Wild Yam Extract 4:1, Wild Yam Extract 6%, Wild Yam Powder, Williams Elder Extract 4:1, Wolfberry Fruit Extract 10:1, Wolfiporia Extract 8:1, Yellow Dock Root Extract 4:1, Yerba Mate Extract (2% caffeine), Yerba Mate Extract 4:1, Yohimbe Bark Extract 15:1, Yohimbe Bark Extract 2%, Yohimbe Bark Extract 3%, Yohimbe Bark Powder, Yucca Extract 4:1, and combinations thereof.

In certain embodiments, plant oils are used in the membranes for improving membrane performance and/or as particulate carriers (i.e., for use in emulsions to carry a desired compound or particle, or as a membrane component encasing a desired compound or particle in a micelle structure for incorporation in the membrane). Such plant oils contemplated are major oils, nut oils, citris oils, gourd oils, and other edible plant oils including, but not limited to, almond, aloe vera, amaranth, apple seed, apricot, argan seed, artichoke, avocado, babassu, beech, ben, bitter gourd seed, black seed, blackberry seed, blackcurrant seed, borage seed, bottle gourd, borneo tallow nut, buffalo gourd, milk butter, butterfat, butternut squash, canola, cape, chestnut, carob pod, cashew, celery seed, circuma longa, cinnamon leaf, clove bud, coconut, cocoa butter, cocklebur, cohune, conjugated linolic acid, coriander seed, corn, cottonseed, cranberry seed, cumin seed, date seed, diacylglycerol, dika, dill seed, egusi, evening primrose, false flax, flaxseed, fennel seed, garlic oil, ginger root, ghee, grape seed, grape fruit seed, guggal lipid, hazelnut, hemp oil, kapok seed, kenaf seed, lallemantia, Indian frankincense, lard, lemon, lime, macadamia, mafura, marula, margarine, meadowfoam seed, mongongo, mustard oil, macadamia, nutmeg butter, okra seed, olive oil, olive leak, orange, oregano, palm oil, papaya seed, peanut oil, pecan, perilla seed, persimmon seed, pequi, pili nut, pine nut, pistachio, pomegranate seed, poppyseed, prune kernel, pumpkin seed oil, pygeum, quinoa, ramtil, rapeseed, raspberry seed, rice bran, rosehip, rosemary, royale, sacha inci, safflower, saw palmetto, sapote, seje, sesame, shea butter, soybean, sunflower, taramira, tea seed, thistle, tiger nut, tobacco seed, tocotrienol palm, tomato seed, walnut, watermelon seed oil, wheat germ, and combinations thereof.

Nutraceuticals are generally thought of as food or food product that reportedly provides health and medical benefits, including the prevention and treatment of disease, and can be defined as a product isolated or purified from foods that is generally sold in medicinal forms not usually associated with food. A nutraceutical may have a physiological benefit or provide protection against chronic disease. Such products may range from isolated nutrients, dietary supplements and specific diets to genetically engineered foods, herbal products, and processed foods such as cereals, soups, and beverages. With recent developments in cellular-level nutraceutical agents, researchers, and medical practitioners are developing templates for integrating and assessing information from clinical studies on complementary and alternative therapies into responsible medical practice.

In certain embodiments, particulate nutraceuticals are used as membrane components, including, but not limited to, 5-Hydroxytryptophan, Acetyl L-Carnitine, Alpha Lipoic Acid, Alpha-Ketoglutarates, Bee Products, Betaine Hydrochloride, Bovine Cartilage, Caffeine, Cetyl Myristoleate, Charcoal, Chitosan, Choline, Chondroitin Sulfate, Coenzyme Q10, Collagen, Colostrum, Creatine, Cyanocobalamin (Vitamin B12), DMAE, Fumaric Acid, Germanium Sesquioxide, Glandular Products, Glucosamine HCL, Glucosamine Sulfate, HMB (Hydroxyl Methyl Butyrate), Immunoglobulin (Immune System Support), Lactic Acid, L-Carnitine, Liver Products, Malic Acid, Maltose-anhydrous, Mannose (d-mannose), MSM, Other Carnitine Products, Phytosterols, Picolinic Acid, Pyruvate, Red Yeast Extract, S-adenylmethionine (SAMe), Selenium Yeast, Shark Cartilage, Theobromine, Vanadyl Sulfate, Velvet Deer Antler, Yeast, ATP, Forskolin, Sterol Esters, Stanol Esters, Probiotics, Lactoferin, Lutein Esters, Zeaxanthin, Immunoglobulins, Ipriflavone, Isoflavones, Fructo-Oligo-Saccharides, Inulin, Huperzine A, Melatonin, Medicinal Mushrooms, Bile Products, Peptone Products, Glandular Products, Pancreatic Products, Thyroid Products, Ribose, Probiotics, oleo resins, Dill Seed oleo resin, Black Pepper oleo resin, Capsicum oleoresin, and combinations thereof.

In certain embodiments, carbon and carbon allotropes are used as membrane components. Not limiting the discussion herein to a particular theory of activity, carbon allotropes, for example spherical fullerenes, may be capable interacting with and form a bonding interaction with free electron pairs of oxygen atoms present in an edible matrix polymer, for example alginate, chitosan, gellan gum, or other matrix polymers as described herein, and combinations thereof. Such an interaction can manifest as an increased in one or more performance characteristics of the membrane matrix relative to a matrix without these particulates. Furthermore, some carbon allotropes, for example spherical fullerenes, have no known toxicity from ingestion, and indeed show free radical scavenging and/or antioxidant characteristics in biological (mammalian) systems, therein potentially providing health benefits in addition to membrane performance enhancement. In certain embodiments, spherical fullerenes (buckyballs) are used having a carbon number of about C₂ₙ, where n=10, 12, 13, 14, 15, 16, 17, 18, 19, 20, 21, 22, 23, 24, 25, 26, 27, 28, 29, 30, 31, 32, 33, 34, 35, 36, 37, 38 39 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, and combinations thereof. In other embodiments, fullerenes are and/or cylindrical nanotubes (buckytubes), single or multi-walled, from about 10 nanometers in length to about 1 millimeter in length. In some embodiments, carbon allotrope concentration by % weight of the polymer matrix is about 0.0001% to about 50%.

### Exemplary Food Objects in Transport Systems

In some embodiments, the transport system resembles a naturally occurring object such as, for example, a fruit, a vegetable, etc. In one example, the transport system resembles an orange and contains material derived from an orange and, optionally, other fruits or foods. Typically, a reconstituted orange has an outer shell formed from an exterior surface material as described herein, and optionally, the outer shell is formed of or contains particles of orange, or contains one or more odorants, colorants, texturants, flavoring agents, or the combination thereof such that the reconstituted orange is similar to an orange in one or more sensory experiences. In some embodiments, the outer shell is moldable and texturized such that it approximates the size (e.g., from about 10 to over 100 square inches of exterior surface area) and a tactile quality of an orange. Reconstituted oranges optionally contain other juices and/or other liquids. The reconstituted orange product is consumed by biting and chewing, or by insertion of a straw through the outer shell to draw out the internal contents. Alternatively, a portion of the outer shell is peeled and the contents consumed with a fork or spoon. In related embodiments, the products are reconstituted grapefruits, and have a size (e.g., from about 30 to over 300 square inches of exterior surface area) and a tactile quality of a grapefruit. The reconstituted grapefruit product is consumed by biting and chewing, or by insertion of a straw through the outer shell to draw out the internal contents. Alternatively, a portion of the outer shell is peeled and the contents consumed with a fork or spoon.

In related embodiments, the products are reconstituted grapes and resemble a grape, having a size in the range of about 0.5 to about 2 inches in length and about 0.2 to about 2 inches in girth, of any color. Such a reconstituted grape contains any variety of wine, fortified wine, or other alcoholic beverage, and/or non-alcoholic juice or extract from grapes or other fruits, containing a volume of liquid in the range of about 0.5 milliliter (ml) to about 300 ml or greater, e.g., 1, 5, 10, 20, 30, 50, 75, 100, 150, 200, 250, 300 or over 300 mls. The reconstituted grape product is consumed by insertion of the entire grape product into the mouth and chewing, by biting and chewing, or by insertion of a straw through the outer shell to draw out the internal contents. Alternatively, a portion of the outer shell is peeled and the contents consumed with a fork or spoon.

In related embodiments, the products are reconstituted watermelons, having a size from about 100 to over 4000 square inches, of any color or pattern. The exterior surface material is generally of sufficient thickness to contain the large volume of the reconstituted watermelon, and in some embodiments an additional outer material or casing is present around the exterior surface material to add rigidity and strength to the product. Such additional outer material or casing is generally easily penetrable to access the contents of the reconstituted watermelon. In some embodiments, the products are reconstituted avocado, having a size from about 8 to over 50 square inches, of any color or pattern, with an outer shell resembling in appearance and touch an avocado, and internal contents containing one or more of avocado, avocado paste, guacamole, and/or beverage such as juice, vegetable oil and/or plant oil. The reconstituted avocado product is consumed by biting and chewing, or by dividing into pieces, by cutting and breaking by hand, and consuming it by itself or in combination with another food product, e.g. salad.

In other embodiments, the food object is a dessert containing chocolate, candy, ice cream, caramel, honey, marmalade, bubble gum, or some combination thereof.

### Beverage Materials for Use in Transport Systems

Beverage materials are generally liquid in form, are capable of providing nutrition and/or hydration when consumed by a subject such as a human, and are typically provided in a form suitable for the gastrointestinal tract of the subject.

In some embodiments, the beverage material contains a juice, such as fruit juice, vegetable juice, berry juice, or some combination thereof. In some embodiments, the beverage material contains an alcoholic beverage such as beer, wine, fortified wine, or a distilled spirit; optionally such alcoholic beverages are mixed with sugar-containing materials or other flavorants, as well as colorants and/or odorants. In some embodiments, the beverage material contains a dairy product, for example, milk, yogurt, cream, or kefir. Typically, such beverage materials are produced under conditions such that the dairy products do not require refrigeration and do not spoil over a substantial period of time as described herein. In some embodiments, the beverage material contains a soda product, meaning a carbonated flavored beverage. These beverage materials are capable of being chilled so as to be consumed in temperature conducive to best taste and enjoyment. In some embodiments, the beverage material contains water, either purified or from a natural source (e.g., mineral water), and optionally contains carbonation and/or flavorants. In some embodiments, the beverage material contains tea or coffee. The product is capable of being chilled or heated so as to provide the consumer flexibility to consume the product at a temperature most appealing to him or her. In some embodiments, the beverage material contains a sports drink, meaning a water-containing beverage that typically contains sugar (e.g., glucose and/or fructose) and optionally contains one or more vitamins and minerals. In some embodiments, the beverage material contains a soup such as tomato soup, a liquid food sauce such as barbeque sauce, fish sauce, or salad dressing, or a semi-liquid food sauce such as guacamole.

### Supplements to Food Materials and Beverage Materials

In some embodiments, food and beverage materials are combined with one or more additional materials: exemplary materials include a vitamin, a mineral, a protein or peptide, dietary fiber material, a lipid, or a combination thereof, as described herein. In some embodiments, the exterior surface materials described herein and/or food or beverage materials contain food particles such as nuts (crushed or not), berries (finely shredded or not), seeds (crushed or not), powders, sugars (crystallized or powdered), and spices.

### Exterior Surface Materials of Transport Systems

Exterior surface materials are generally those materials capable of being in contact with food materials or beverage materials so as to contain these materials in three dimensions, typically by interacting with the exterior surfaces of the food or beverage materials. As provided herein, a layer of an exterior surface material, for example a membrane polymer, particulates, and/or a combination of membrane polymer and particulates, is disposed on a food or beverage material so as to essentially completely cover the food or beverage material. In certain embodiments, it is desirable that the exterior surface material is moldable, meaning that the surface material, either in isolation or when contacted with the food or beverage material, is capable of adopting and retaining a desired three dimensional shape. An exterior surface material may be moldable to take the shape or form of a fruit or vegetable, or of a consumer product such as a coffee cup, soda can or bottle, or the like.

Generally, the exterior surface material is not altered in shape or consistency when handled, such as by a consumer. Thus, the exterior surface material generally does not melt or soften, or rupture or otherwise release the contents of the food or beverage object containing the exterior surface material, with typical handling.

In some embodiments, the exterior surface materials of the invention have useful combinations of properties. For example, the surface materials have a thickness in the range of about 10 micron to about 200 mm. In some embodiments, the surface materials have a moisture content in the range of about 10 to about 80%, although the exterior surface materials can optionally be dried or hydrated prior or subsequent to the production process. In some embodiments, the melting temperature of the exterior surface materials ranges from about 30 to about 772 degrees Celsius. The weight of the exterior surface materials may be in the range of about 15 to about 45 grams per 1 square inch sheet of surface material having a thickness of 1 inch. For example, provided are exterior surface materials containing calcium, which has a density of 2.15 g per cubic centimeter. In some embodiments, the exterior surface materials are edible or non-edible, and biodegradable or non-biodegradable.

In some embodiments, the exterior surface materials resemble, taste and smell like a food product or products contained within them. For example, the exterior surface resembles the skin of an orange with orange juice contained within it, or the skin of an apple and pineapple with apple juice and pineapple juice contained within it, whether mixed together or kept separately, thus creating new, yet seemingly familiar environments to experience a certain food or liquid product. Similarly, the exterior surface can bear close, distant, or in-between close and distant resemblance to any combination of any number of foods. In some embodiments, the exterior surface materials do not resemble, taste, or smell like the food or beverage material contained within them. Similarly, in some embodiments, the exterior surface materials resemble, taste, or smell like a particular food or liquid product (for example, an orange, as described herein) but the food or beverage material contain one or more different food or beverage products. Furthermore, in some embodiments, the exterior surface materials have an abstract or unique shape, not resembling an existing food or liquid product. In related embodiments, the exterior surface materials have hybrid shapes, which are expressed as combinations of both abstract or unique shape and resemblance to one or more food products. In related embodiments, the exterior surface materials have shapes or resemblances that appear inedible, for example, an inanimate object such as a house. Such embodiments create opportunities to excite and surprise consumers of reconstituted foods and beverages with new sensory experiences. Consumers typically consume various foods and beverages in combination with each other, and this approach provides these consumers an opportunity to continue this dietary habit while enjoying new combinatorial experiences.

In some embodiments, the exterior surface materials, separating membrane or internal content are composed only of ingredients adhering to standards of kosher certification, as well as to dietary standards desired and expected by individuals who are vegetarian or vegan.

Tensile strength characteristics are important attributes for the surface materials of the transport systems. The tensile strength determines the maximum strength of a surface material and the elastic modulus and elongation will determine the flexibility of a surface material. Additionally, compressive stress characteristics, defined as the capacity of a material or structure to withstand axially directed pushing forces, are also important attributes for the surface materials of the invention.

Flavor, odor, color, and texture are important elements to almost any food or food product. In some embodiments, the exterior surface materials are provided having one or more flavors that may or may not be different from the natural flavors of the food or beverage products contained therein. Flavorings can be natural, artificial, or combine in some proportion both natural and artificial ingredients. According to the Code of Federal Regulations, a natural flavoring is: “the essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or similar plant material, meat, seafood, poultry, eggs, dairy products, or fermentation products thereof, whose significant function in food is flavoring rather than nutritional.” Flavorings that do not meet the above requirements are considered artificial.

In some embodiments, the exterior surface materials are provided having one or more colors that may or may not be different from the natural colors of the food or beverage products contained therein. Some examples of colorants approved by the Food and Drug Administration are anthocyanin (blueberry and cherry colors), flavonoids (cocoa colors), phycoerythrin (layer colors), carotenoids (orange colors), polyphenol (persimmon colors), and more. Maximum heavy metal tolerance for colorants is generally at 40 parts per million or below.

In some embodiments, the exterior surface materials will have a texture or textures that may or may not be different from the natural textures prevalent in the food or beverage products contained beneath the exterior surface materials. Examples of texturants approved by the Food and Drug Administration include hydrocolloids, which assist with stabilization, suspension and thickening; pectins, which are derived from citrus peels or sugar beets; gelatin; or inulin, which is a natural plant ingredient that provides fiber enrichment.

In some embodiments, the exterior surface materials are combined with one or more odorants that may or may not be different from the natural odorants, if any, present in the food or beverage materials contained beneath the exterior surface materials. These embodiments enable consumers to have sensory-dietary experiences in ways that were not possible or available previously.

As described herein, a multitude of properties of the food and beverage objects provided herein can be modulated when the food and beverage objects are produced. For example, the size of the food and beverage object, along with the external surface area, thickness or thinness of the exterior surface material, and the internal volume, can be modulated. Similarly, the shape, taste, color, texture, smell, and/or mass of the overall product and the shape(s) of its internal content can be modulated.

### Storage of Food and Beverage Transport Systems

It is generally desirable that food and beverage objects exhibit long-term stability and not subject to spoiling or deterioration. In some embodiments, the object retains its shape, color, taste, and internal composition for a period in the ranges from several hours to 1 day, 1 day to 3 days, 3 days to 1 week, 1 week to 2 weeks, 2 weeks to 1 month, 1 month to 3 months, 3 months to 6 months, 6 months to 1 year or over 1 year. In some embodiments, the product or constitutive parts will have water activity levels in the ranges from 0.1 to 0.3, 0.3-0.5, 0.5-0.8, or 0.8-1. Water Activity is defined as the amount of unbound, free water in a system available to support biological and chemical reactions (Potter, Food Science, 4th Ed., p. 296, AVI Publishing Co., Westport, Conn. (1986)). Some foods may have high levels of total water content while at the same time possess low water activity. Food designers use water activity to formulate products that are shelf stable. If a product is kept below a certain water activity, then mold growth is inhibited. This results in a longer shelf-life. Water activity values can also help limit moisture migration within a food product made with different ingredients.

It is desirable to possess flexibility in endowing all materials that are encased within the exterior surface materials with varying degrees of liquidity, semi-liquidity, viscosity, solidness, and/or frozenness. In some embodiments, the internal content of the transport system is juice that is liquid. In some embodiments, the internal content is the same kind of juice, but one that is viscous. Viscosity can be important for preventing rapid spillage of the internal content when the exterior surface materials are broken, separated, peeled or cut off in the event of the commencement of consumption.

Viscosity in liquids can be achieved by utilization of viscosity agents, which are substances that swell in water to form a gel. An example of a viscosity agent is methylcellulose, which is a methyl ester of cellulose prepared by the methylation of natural cellulose.

In related embodiments, the internal content of the transport system is an alcoholic beverage, for example, wine, cognac, gin, or some combination thereof, that is liquid. In some embodiments, the internal content is the same of kind of alcoholic beverage, but one that is viscous and/or completely frozen. Among other things, these and similar embodiments convey the fact that the method of consumption that is convenient and enjoyable can differ from one situation to another, and that internal contents of the product can be manipulated to create the desired convenience and enjoyment for the consumer.

### Example 1

### Preparation of an Alginate Shell Containing Particles

By adjusting the properties of an alginate solution, a membrane can be designed to be stronger, thinner/thicker, or taste in a particular way, by adding suspended particles of food, e.g. chocolate, nuts, seeds, caramel, fruit or vegetable fragments (e.g., orange rind), or other particles at least partially insoluble in water.

The particles can be sized (e.g., chosen or formed) such that the maximum dimension of the container formed by the membrane is about 10 or 20 or 50 or 100 times larger (or more) than the maximum dimension of the particles.

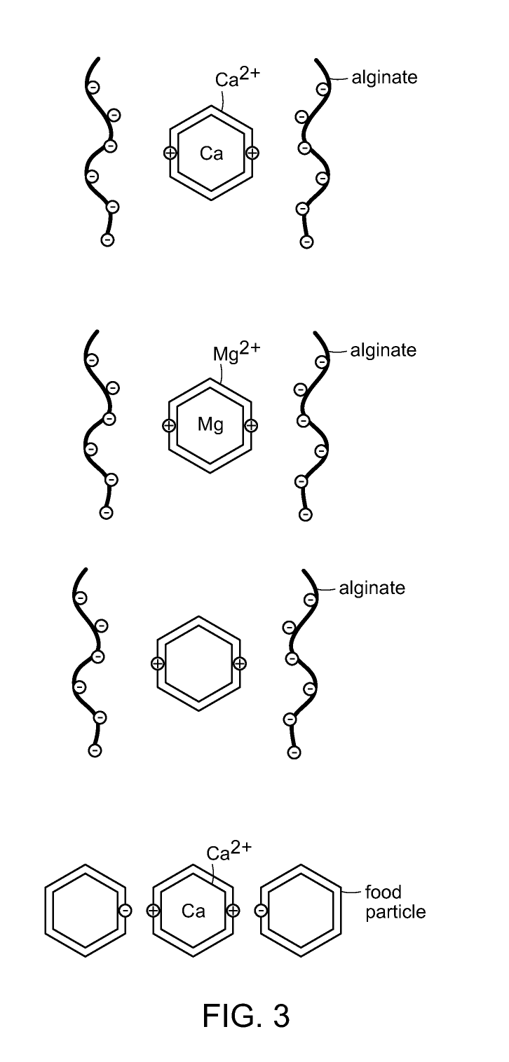

Often these particles will be charged (i.e., most particle surfaces have some charge or zeta potential). This charge can be modified by the way each particle is created, its size, and the nature of the particle surface. Surfactants can be added to enhance the charged nature and the ionic atmosphere of the water can also be modified beneficially. When in solution (e.g., alginate or an aqueous medium), these particles (assuming they are zwitterionic or oppositely charged to the membrane forming material, such as the alginate) will undergo strong or weak associations with alginate but not so strong as to cause gel formation. When in contact with calcium, for example, particles will form with alginate a gelled membrane through interaction of the calcium and food particles trapped within the membrane, possibly strengthening it, improving flavor, etc. FIG. 3 schematically illustrates the interaction between positively charged particles (e.g., Ca²⁺ or Mg²⁺) with negatively charged alginate or food particles. The maximum weight of the added material (e.g., chocolate particles) relative to the alginate, can be quite large, i.e., far larger than 1:1 ratio of particles to alginate by mass. This will depend on the desired membrane nature as well as the nature of the particles and the interactions they may have with calcium and alginate.

These same methods can be extended to many kinds of small particles with a charge, thus creating a new class of membrane, formed by a charged polymer, such as alginate, and charged particles, with or without the addition of a multivalent cation such as calcium.

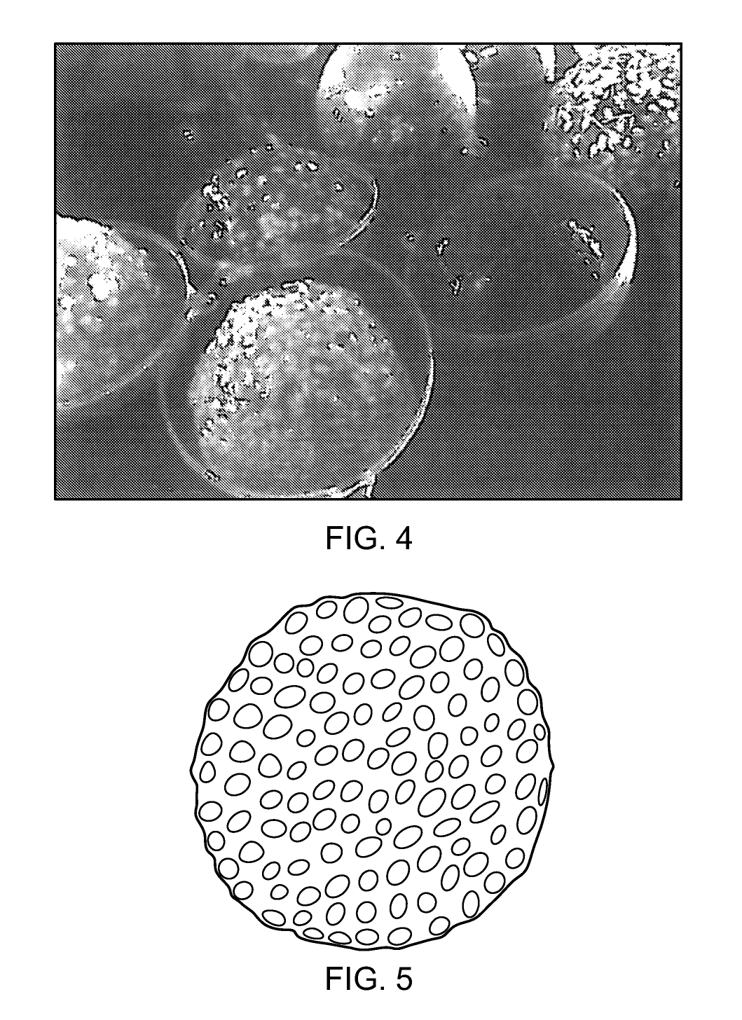

FIG. 4 illustrates various transport systems having membrane layers containing different particles (e.g., edible particles). By way of an example, membrane layers can include differently sized particles, different types of particles, or different orientations or configurations of particles. The membrane layers of the transport system can have various sized characteristic dimensions (e.g., diameters). In some embodiments, the diameter of a membrane layer is greater than 1.5 centimeters (e.g., 2 centimeters, 3 centimeters, 4 centimeters, 5 centimeters, 7.5 centimeters, 10 centimeters, 15 centimeters, or 20 centimeters, or greater). Additionally, the transport systems can be enclosed in various shells for packaging, transportation, or storage.

Referring to FIG. 5, in some embodiments, a membrane layer around an ingestible substance includes large particles suspended in the alginate polymer matrix. The large particles can provide structural stability to the membrane and help reduce the likelihood of deformation or the membrane. Such a membrane can have an unusual (e.g., non-spherical) shape. Additionally, large particles can reduce the likelihood of evaporation of the membrane and/or the fluid inside the membrane. Having embedded particles exposed to the exterior of the membrane can also provide a more rigid and/or less sticky surface for holding the vessel. The large particles can have a characteristic dimension (e.g., mean diameter of a sphere or length or radius of a cylinder) that is, for example, roughly about 1 mm to about 30 mm (e.g., about 2 mm to about 5 mm) In some embodiments, the large particles have a diameter that is less than ⅕, less than 1/10, or less than 1/20 of the diameter of the membrane layer.

Some examples of large particles are large seeds (e.g., sesame seeds, linseed), grains, puffed grains (e.g., puffed quinoa or puffed rice), fruit or vegetable pieces (e.g. lemon or orange peel, rind, zest), and nuts. In some cases, these are prepared by blending or grating. In some embodiments, the membrane layer includes one or more different types of large particles.

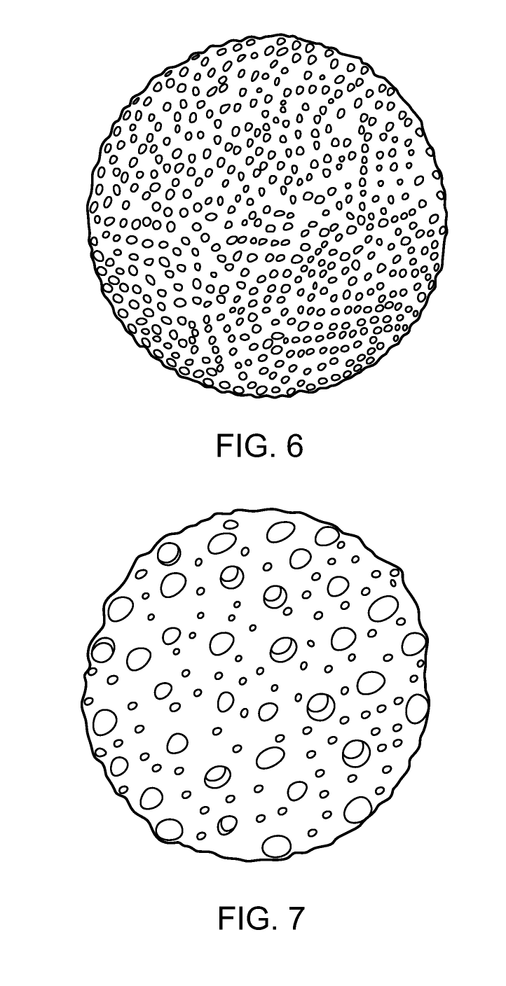

Referring to FIG. 6, in some embodiments, a membrane layer includes small particles suspended in the alginate polymer matrix. The small particles typically have a characteristic dimension (e.g., diameter) that is less (e.g., much less) than 1/10 or 1/50 or 1/100 of the diameter of the membrane. Such small particles can also improve the evaporation properties of the membrane layer, some structural stability, and improve the texture and handling of the vessel. For example, the small particles can have a diameter that is, for example, roughly about 0.1 microns to about 3 mm (e.g., about 0.2 mm to about 1.5 mm).

Some examples of small particles are small seeds (e.g., poppy seeds, chia seeds), small grains, pulverized fruit or vegetable skin, and pulverized seeds. In some embodiments, the membrane layer includes one or more different types of small particles.

Referring to FIG. 7, in some embodiments, a membrane layer includes a mixture of both the large and small particles suspended in the alginate polymer matrix. In some embodiments, a characteristic dimension (e.g., diameter) of the small particles is less than 75% (e.g., less than 50%, less than 25%, less than 10%, less than 5%, or less than 1%) of a corresponding characteristic dimension of the large particles also suspended in the membrane. In some embodiments, a ratio by weight of the large particles suspended in the membrane to the small particles suspended in the membrane is about 1:2 to about 2:1. For example, an edible bottle may have roughly 4 grams puffed quinoa, 2 grams poppy seeds, and 2 grams sesame seeds.

The membrane layer having both large and small particles has been shown to produce better particle packing and arrangement within the membrane layer, possibly better structural integrity, reduced water evaporation from the membrane or the fluid contained therein, and forming more useful textures than membrane layers having only large or small particles.

For example, samples having puffed quinoa, linseed, sesame seed, poppy seed, and/or chia seed were tested. The tested samples with both large and small particles were shown to maintain adequate evaporation and structural properties for up to 1-2 weeks, whereas similar membrane layers having no particles suspended in the membrane were shown to maintain similar structural properties for only 48 hours. Membranes with only large or small particles, or with fewer particles, were shown to generally maintain similar structural properties for an intermediate duration (i.e., in some cases, between 48 hours and 1 week).

It is also important to note that particles of a variety of sizes can be used together, even if the sizes do not clearly correspond to “large” and “small”. The distinction between large and small particles described here is meant to be exemplary of having particles of more than one typical size in a membrane. In some embodiments, there will be one kind of “large” particle and one kind of “small” particle; in other embodiments, there may be more than two kinds (i.e. characteristic sizes) of particles, or there may be more than one kind of “large” particle, or there may be more than one kind of “small” particle, etc. Overall, the mixture of larger and smaller particles generally leads to tighter packing of the particles.

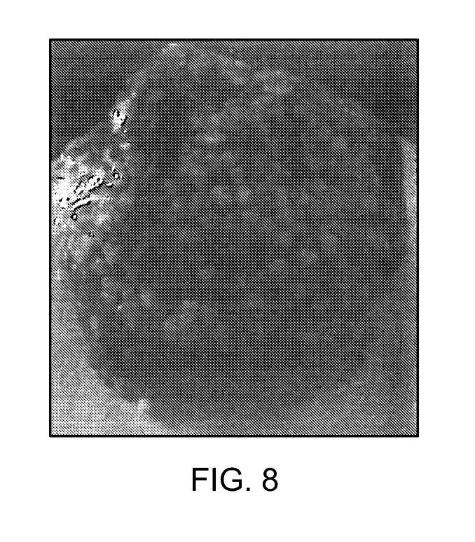

In some embodiments, transport systems are formed as non-spherical, non-uniform shapes. Referring to FIG. 8, a membrane of a transport system can include ridges or features for aesthetic and/or structural purposes. As discussed below, in some embodiments, the transport system is constructed to resemble naturally occurring objects (e.g., fruits and vegetables). In some cases, the membrane is formed to be non-spherical by forming a non-spherical object on which the membrane is applied. For example, to make a cylindrical membrane, a cylindrical frozen object can be molded or sculpted and a membrane subsequently formed thereon. However, non-spherical or non-uniform shapes are also created by other means. For example, in the membrane solutions, random particle arrangements, agglomeration, higher viscosity, and particle packing during the formation of the membrane, can lead to unusual shapes. It is believed that larger particles in the membrane tend to increase the likelihood of getting unusual (non-spherical) shapes, and that these also increase the overall rigidity of the membrane. Such non-homogeneous shapes can be used to create “substructures” in the membrane, whereby perhaps taste, dosage release, or other properties are modulated by the presence of agglomerates, or other particle formations.

It will be understood that various modifications may be made without departing from the spirit and scope of the invention. The exemplary membranes discussed above are generally 5-6 cm, but membranes of 7-8 cm and larger as well as smaller “grape” or “raisin” membranes (1-3 cm) can be constructed from the methods and materials described herein.

What is claimed is:

1. An edible transport system, comprising:
an edible or potable substance; and
a cross-linked matrix encapsulating the edible or potable substance, the cross-linked matrix comprising at least two different edible polymers.

2. The edible transport system of claim 1, wherein the at least two different edible polymers are charge cross-linked by multivalent ions, including cross-linking interactions between the edible particles and edible polymer or plurality of edible polymers via bridges formed by the multivalent ions.

3. The edible transport system of claim 1, wherein the at least two different edible polymers selected from the group consisting of a positively charged edible polymer, a neutrally charged edible polymer, a negatively charged edible particle, an amphipathic edible polymer, a zwitterionic edible polymer, and combinations thereof.

4. The edible transport system of claim 1, wherein the at least two different edible polymers comprise polysaccharides selected from the group consisting of a hydrocolloid, shellac, and fibers.

5. The edible transport system of claim 4, wherein the at least two different edible polymers comprise a hydrocolloid selected from the group consisting of an alginate, an agar, a starch, a gelatin, carrageenan, xanthan gum, gellan gum, galactomannan, gum arabic, a pectin, a milk protein, a cellulosic, a carboxymethylcellulosic, a methylcellulosic, gum tragacanth and karaya, xyloglucan, curdlan, a cereal β-glucan, soluble soybean polysaccharide, a bacterial cellulose, a microcrystalline cellulose, chitosan, inulin, an emulsifying polymer, konjac mannan/konjac glucomannan, a seed gum, and pullulan.

6. The edible transport system of claim 5, wherein the hydrocolloid comprises an alginate selected from the group consisting of sodium alginate, ammonium alginate, potassium alginate, and propylene glycol alginate.

7. The edible transport system of claim 1, further comprising edible particles in the cross-linked matrix.

8. The edible transport system of claim 7, wherein the edible particles are one of the group consisting of a positively charged edible particle, a neutrally charged edible particle, a negatively charged edible particle, an amphipathic edible particle, a zwitterionic edible particle, and combinations thereof.

9. The edible transport system of claim 7, wherein the edible particles provide enhanced performance to the matrix.

10. The edible transport system of claim 7, wherein edible particles are selected from the group comprising a hydrocolloid, shellac, fibers, bagasse, tapioca, chitosan, sugar derivatives, chocolate, seaweed, and combinations thereof, and wherein the particles comprise a compound different from the polymer compound.

11. The edible transport system of claim 7, wherein the edible particles are particles selected from the group consisting of particles of a food, particles of an energy supplement, particles of a dietary supplement, particles of a confection, particles of a nutraceutical, particles of a pharmaceutical, particles of a sleep aid compound, particles of a weight loss compound, particles of a powdered vegetable, particles of a flavoring agent, particles of a sweetener, carbon allotropes, particles of a metabolic intermediate of a pharmaceutical, particles of a metabolic by-product of a pharmaceutical, and combinations thereof.

12. The edible transport system of claim 7, wherein the edible particles comprise a size having a volume mean distribution between about 0.1 microns and about 1.0 microns, between about 0.1 microns and about 10.0 microns, between about 0.1 microns and about 100.0 microns, between about 0.1 microns and about 1.0 millimeters, between about 0.1 and about 3 millimeters.

13. The edible transport system of claim 1, wherein the cross-linked matrix further comprises an edible oil.

14. The edible transport system of claim 1, wherein the edible or potable substance comprises at least one of a powder, a gel, an emulsion, a foam, a solid, and combinations thereof.

15. The edible transport system of claim 14, wherein the edible or potable substance is selected from the group consisting of fruit, vegetable, meat, a dairy product, a carbohydrate food product, a botanical, an energy supplement, a dietary supplement, a confection, a nutraceutical, a pharmaceutical, a sleep aid compound, a weight loss compound, a powdered vegetable, a flavoring agent, a sweetener, a powdered food product, and combinations thereof.

16. The edible transport system of claim 1, wherein the edible substance comprises a liquid, particularly wherein the liquid comprises at least one of water, an alcohol, a juice, an alcohol mixed drink, a coffee product, a tea product, a soft drink, an energy supplement product, a dietary supplement, a confection, and combinations thereof.

17. An edible transport system, comprising:
an edible or potable substance;
a first cross-linked matrix encapsulating the edible substance;
a second cross-linked matrix encapsulating the first cross linked matrix; and
edible particles with at least one of the first cross-linked matrix and the second cross-linked matrix.

18. The edible transport system of claim 17, wherein the edible particles are one of the group consisting of a positively charged edible particle, a neutrally charged edible particle, a negatively charged edible particle, an amphipathic edible particle, a zwitterionic edible particle, and combinations thereof.

19. The edible transport system of claim 17, wherein the edible particles provide enhanced performance to the matrix.

20. The edible transport system of claim 17, wherein edible particles are selected from the group comprising a hydrocolloid, shellac, fibers, bagasse, tapioca, chitosan, sugar derivatives, chocolate, seaweed, and combinations thereof, and wherein the particles comprise a compound different from the polymer compound.

21. The edible transport system of claim 17, wherein the edible particles are particles selected from the group consisting of particles of a food, particles of an energy supplement, particles of a dietary supplement, particles of a confection, particles of a nutraceutical, particles of a pharmaceutical, particles of a sleep aid compound, particles of a weight loss compound, particles of a powdered vegetable, particles of a flavoring agent, particles of a sweetener, carbon allotropes, particles of a metabolic intermediate of a pharmaceutical, particles of a metabolic by-product of a pharmaceutical, and combinations thereof.

22. The edible transport system of claim 17, wherein the edible particles comprise a size having a volume mean distribution between about 0.1 microns and about 1.0 microns, between about 0.1 microns and about 10.0 microns, between about 0.1 microns and about 100.0 microns, between about 0.1 microns and about 1.0 millimeters, between about 0.1 and about 3 millimeters.

23. The edible transport system of claim 17, wherein the at least one of the first cross-linked matrix and the second cross-linked matrix further comprise an edible oil.

24. The edible transport system of claim 18, further comprising a particle layer arranged between each cross-linked matrix.

25. The edible transport system of claim 24, wherein the particle layer comprises particles selected from the group consisting of particles of a food, particles of an energy supplement, particles of a dietary supplement, particles of a confection, particles of a nutraceutical, particles of a pharmaceutical, particles of a sleep aid compound, particles of a weight loss compound, particles of a powdered vegetable, particles of a flavoring agent, particles of a sweetener, particles of a metabolic intermediate of a pharmaceutical, particles of a metabolic by-product of a pharmaceutical, and combinations thereof.

26. A method of preparing an edible composition, comprising the steps of:
providing an edible substance;
encapsulating the edible substance in a cross-linked matrix comprising at least two different polymers.

27. The method of claim 25, wherein the edible polymer and the edible particles or the plurality of edible polymers are charge cross-linked by multivalent ions, including cross-linking interactions between the edible particles and edible polymer or plurality of edible polymers via bridges formed by the multivalent ions.

28. The method of claim 25, wherein the edible polymer is one of the group consisting of a positively charged edible polymer, a neutrally charged edible polymer, a negatively charged edible particle, an amphipathic edible polymer, a zwitterionic edible polymer, and combinations thereof.

29. The method of claim 25, wherein the polymer comprises a polysaccharide selected from the group consisting of a hydrocolloid, shellac, and fibers.

30. The method of claim 25, wherein the polymer comprises a hydrocolloid selected from the group consisting of an alginate, an agar, a starch, a gelatin, carrageenan, xanthan gum, gellan gum, galactomannan, gum arabic, a pectin, a milk protein, a cellulosic, a carboxymethylcellulosic, a methylcellulosic, gum tragacanth and karaya, xyloglucan, curdlan, a cereal β-glucan, soluble soybean polysaccharide, a bacterial cellulose, a microcrystalline cellulose, chitosan, inulin, an emulsifying polymer, konjac mannan/konjac glucomannan, a seed gum, and pullulan.

31. The method of claim 30, wherein the hydrocolloid comprises an alginate selected from the group consisting of sodium alginate, ammonium alginate, potassium alginate, and propylene glycol alginate.

32. The method of claim 25, wherein the cross-linked matrix further comprises edible particles.

33. The method of claim 32, wherein the particles are selected from the group consisting of particles of a hydrocolloid, particles of shellac, fibers, particles of bagasse, particles of tapioca, particles of chitosan, particles of sugar derivatives, particles of chocolate, particles of seaweed, and combinations thereof, and wherein the particles comprise a compound different from the polymer compound.

34. The method of claim 32, wherein the edible particles comprise a size having a volume mean distribution between about 0.1 microns and about 1.0 microns, between about 0.1 microns and about 10.0 microns, between about 0.1 microns and about 100.0 microns, between about 0.1 microns and about 1.0 millimeters, between about 0.1 and about 3 millimeters.

35. The method of claim 32, wherein the edible particles are particles are selected from the group consisting of particles of a food, particles of an energy supplement, particles of a dietary supplement, particles of a confection, particles of a nutraceutical, particles of a pharmaceutical, particles of a sleep aid compound, particles of a weight loss compound, particles of a powdered vegetable, particles of a flavoring agent, particles of a sweetener, particles of a metabolic intermediate of a pharmaceutical, particles of a metabolic by-product of a pharmaceutical, and combinations thereof.

36. The method of claim 32, wherein the edible particles provide improved performance to the matrix.

37. The method of claim 32, wherein the edible particles are one of the group consisting of a positively charged edible particle, a neutrally charged edible particle, a negatively charged edible particle, an amphipathic edible particle, a zwitterionic edible particle, and combinations thereof.

38. The method of claim 26, wherein the cross-linked matrix further comprises an edible oil.

39. The method of claim 26, wherein the edible substance comprises at least one of a powder, a gel, an emulsion, a foam, a solid, and combinations thereof.

40. The method of claim 39, wherein the edible substance is selected from the group consisting of fruit, vegetable, meat, a dairy product, a carbohydrate food product, a botanical, an energy supplement, a dietary supplement, a confection, a nutraceutical, a pharmaceutical, a sleep aid compound, a weight loss compound, a powdered vegetable, a flavoring agent, a sweetener, a powdered food product, and combinations thereof.

41. The method of claim 26, wherein the edible substance comprises a liquid, particularly wherein the liquid comprises at least one of water, an alcohol, a juice, an alcohol mixed drink, a coffee product, a tea product, a soft drink, an energy supplement product, a dietary supplement, a confection, and combinations thereof.
